(19) United States
(12) Patent Application Publication
(10) Pub. No.: US 2002/0165728 A1
(43) Pub. Date: Nov. 7, 2002

(54) Device, method and computer program product for carrying out business processes

(76) Inventor: Jochen Buckenmayer, Stuttgart (DE)

Correspondence Address: HEWLETT-PACKARD COMPANY, Intellectual Property Administration, P.O. Box 272400, Fort Collins, CO, 80527-2400, US

(21) Appl. No.: 09/956,362

(22) Filed: Sep. 19, 2001

Related U.S. Application Data
(63) Continuation-in-part of application No. 09/425,360, filed on Oct. 22, 1999.
(63) Continuation-in-part of application No. 09/700,433, filed on Feb. 5, 2001.

(30) Foreign Application Priority Data
Mar. 15, 1999 (DE) 19911373.4

(51) Int. Cl. G06F 17/60

(52) U.S. Cl. 705/1

(57) ABSTRACT

For conducting a business process within an information network divided into a pro-prietary and a non-proprietary part, a functional element arranged outside the proprietary part, and a data flow control element arranged within it are proposed. Further, a device for conducting a business process is proposed, which is equipped with an automatic attribute state modifier, particularly in the form of a timer.

This is a continuation in part of U.S. patent application Ser. No. 09/425,360, entitled “Arrangement and Method for Conducting Business Processes in a Distributed Process Network,”filed Oct. 22, 1999, and U.S. patent application Ser. No. 09/700,433, entitled “Device, Method and Computer Program for Carrying Out Business Processes,” filed Feb. 5, 2001.

### BACKGROUND OF THE INVENTION

1 Field of the Invention

The invention generally relates to data processing systems or distributed information networks in which business processes are conducted. In particular, the invention concerns devices for conducting a business process with a sequence of events, which is processed by means of a data processing system and is represented by digital data. Further, the invention relates to methods for conducting the corresponding business processes and to a corresponding computer program product.

2. Description of the Prior Art

In a company, marketing campaigns and marketing activities generate a multitude of information. Example scenarios are trade fair activities, phased mailing campaigns (mailings) of a direct marketing, or business activities in special programs such as the current Year 2000 programs. Of special relevance is certain information reflecting a customer's intent to purchase. According to their classification, they are handled at different locations in the company. If a simple request for literature is involved, a literature center, if any, would be responsible. If it concerns a concrete intent of the customer to purchase in a certain volume, however, the purchase inquiry will generally be handled by a sales representative responsible in this case. If the inquiry is a general one or if the volume is low, however, this inquiry must usually be forwarded to partner companies or to a proprietary customer information system.

In the handling of business processes today, it is not possible to track, in overview form, all purchase intentions existing in the company and to direct them into an appropriate distribution channel according to the respective quality of an inquiry. Furthermore, it is not possible in the known business processes to perform a classification of the cited business activities (so-called “lead tracking process”) according to success criteria.

### SUMMARY OF THE INVENTION

The object of the invention is to provide a device as well as a method of the type described initially, which avoid the aforementioned disadvantages of the prior art and in particular enable clear tracking of the business processes effected thereby within the company, linked together by means of information technology. Another object is to be able to conduct business processes in a uniform way despite different processing requirements. The entire sequence i.e., from the generation of a lead to project termination, should be understandable in a completely electronic form (closed loop). Finally, the expenditure for introducing the subjects involved to the business processes will be reduced.

Correspondingly, according to a first aspect of the invention for a device of the type named initially, the business process is conducted within an information network divided into a proprietary part and a non-proprietary part, wherein a central data store is provided for storing the events within the proprietary part of the information network. According to the first aspect for the device according the invention, it is proposed to provide a functional element located outside of the proprietary part of the information network for changing at least one attribute in at least one part of the sequence. A data flow control element which is provided within the proprietary part of the information network serves for controlling data flows assigned to the events in at least one part of the sequence and has means for examining said at least one attribute as well as means for controlling the data flow corresponding to the respective the state of an attribute.

In other words, the invention according to its first aspect offers a device for conducting a business process having a sequence of events, which is processed within an information network divided into a proprietary part and a non-proprietary part by means of a data processing system and is represented by digital data, wherein at least one sequence of at least first events is generated, whereby at least one sequence of at least second events which is constructed on the first events is [also] generated, wherein a central data store for storage of at least said first and at least said second events is provided within the proprietary part of the information network, with at least one functional part provided outside the proprietary part of the information network for generating attributes characterizing a state of said at least first and said at least second events; at least one data flow control element provided within the proprietary part of the information network for control of the data flows assigned to said at least first and said at least second events, having means for examining the attributes assigned to the first and second events, and means for controlling the data flow according to the respective states of the attributes. As an example, the “first event” is the generation of a lead, whereas the “second event”, for example, is the processing of a lead, i.e., its assignments to a sales representative. “Sequence of events” is to be understood, for example, as the lead generating and processing process or parts thereof.

Preferably, the data flow control element also has means for changing said at least one attribute. For example, the data flow control element is responsible for changing the attribute in one or more parts of the event sequence, while on the other hand, the functional element is responsible for this change in one or more different parts [of the sequence]. Accordingly, the functional element may also have means for controlling the data flows assigned to the events. Thus, for example, the control of these data flows may also be taken over in one or more parts of the event sequence by the data flow control element, whereas in one or more other parts, control is assumed by the functional element. Thus, advantageously, the data flow control element and the functional element cooperate in such a way that both are responsible for the change in the attribute and control of the data flow, whereby this is done preferably sequentially and not simultaneously, in order to avoid collision.

Preferably, the device also has means for making possible an access to the data store over the information network by means of access authorization. Advantageously, this access is also possible from the non-proprietary part of the information network, so that, for example, sales personnel of the enterprise—who lack access authorization, but no persons outside the company—can also contribute to the business process or can at least observe it from outside (e.g., via the Internet).

The invention preferably provides for implementing a general or generalized lead tracking process using a data flow-control element in the form of an intranet Web tool. In the case of the information network (both the proprietary and non-proprietary parts) there is preferably a TCP/IP network with HTTP protocol, whose non-proprietary part is advantageously coupled to the Internet. A particular aspect of the invention consists of the creation of a type of “bulletin board” on which notes (leads) are posted that are accepted as assignments by the sales representative (SR) in the company who feels responsible for the lead. The “notes” are marked accordingly when sales representatives have accepted them. An alternative approach in lead assignment provides for the person who is responsible for entering a lead to assign it according to a customer list.

All in all, a comprehensive overview is attained at any time of what leads are available or have been assigned to a particular sales representative. Leads to which no sales representative has been assigned after a certain time can be forwarded, using the proposed tool, to a specific partner company. These companies are charged with returning the results.

Because the status of the lead (e.g., open, assigned, closed) can be tracked, a so-called lead report can be generated, giving an overview of current lead activities. The advantage in implementing the lead tracking process via the intranet lies in particular in the fact that the leads can be entered independently of location and individual and can be tracked by all authorized persons via the respective Internet home page of the company in which the proposed Web tool is integrated.

Furthermore, the invention allows for lead reporting by which, for example, the company's management can precisely track, and accordingly control, sales activities. Currently, it requires additional effort to re-enter leads, which exist in the company in the form of written notes, faxes, lead forms, etc., into a Web screen. However, it is assumed that this additional effort is certainly justifiable in the light of the aforementioned advantages.

Leads, which result from marketing actions internal to the company or directly from inquiries directed to the company are preferably generated in the proprietary part of the information network. Today, many leads no longer result from marketing campaigns internal to the company, but are generated by telemarketing or mailing agencies placed under contract. Preferably, a so-called “lead information system” (LIS) is made available to the subjects outside the proprietary network in the non-proprietary network part, by means of which the leads can be taken over in electronic form by the respective agencies, and the leads can be transferred, for example, electronically to the central data store. In such cases, therefore, no company-internal resources are required for conducting the initially cited business processes. Also, the aforementioned partner companies which assume processing of the “sorted out” leads also require the Lead Information System or a corresponding tool.

According to a preferred embodiment of the invention, it can be provided that the functional element has at least one functionality or portion thereof of the data flow control element in the form of a static copy. This guarantees that a subject participating in a present business process but located outside of the proprietary information network does not have online access to the proprietary core data for the business process in the central data store, but can still participate in the business process by appropriate input by means of the functional element. The functional element can serve in an advantageous manner to capture the leads, thus the first events. Preferably, the initial uptake of events can be undertaken both in the proprietary part by means of the data flow control element as well as the non-proprietary part by means of the functional element.

In order to simplify the required inputs within an overall business process, a unified format of the elements representing the data flow can be provided. In order to also be able to supply current data of a business process to a subject located outside the proprietary network, the functional element can have means for synchronizing the data elements representing the data flow. For an exchange of respective data, the functional element can additionally provide means for sending and receiving the data elements representing the data flow. To allow for the intervention of the externally located subject into the business process, the functional element can additionally have means for the manipulation of the data elements representing the data flow.

In further developing the concept of the invention, it can be provided that the data flow control element has means for importing data elements as well as means for analysis and evaluating the elements.

According to a preferred enhancement of the proposed device according to the invention, it can be provided that the data flow control element is hypertext-based. This allows for simple online access by an authorized subject to the proprietary part via the Internet or another open network. Because the functional element is independent of the respective operating system platform, a subject located outside of the proprietary network can be provided with a functional element independently of the respective operating system present, by means of which the subject can communicate with the data flow control element.

Various configurations are possible with respect to the architecture of the non-proprietary part of the network. In a first configuration, the functional element is installed for each external subject who participates in the business process, and this is done, e.g., on his host computer. The communication between the functional element and the data flow control element is then conducted via an open network, e.g., the Internet. For example, data files, which have as contents, e.g., copies of the data elements, are sent between the external subject and the proprietary network part in both directions for this purpose. In this configuration, the “functional element” runs named applications each time in copies for a multiple number of external subjects. This architecture is thus associated with a certain expenditure for software and data maintenance. In a second, preferred configuration, however, both applications, thus both the data flow control element as well as the functional element are assigned to the direct authorization region of the company and thus run, for example, in its intranet, wherein the data flow control element is localized in the proprietary part of the intranet and the functional element is localized in its non-proprietary part. The functional element is coupled with an open network, for example, by means of an HTTP server with the Internet. In the case of this second configuration, the functional element is not (or at least not permanently) installed in the case of individual external subjects. Rather, the latter access the functional element by means of a communication program, e.g., an Internet browser over the open network (Internet). The latter element, in turn, can communicate with the data flow control element set up in the proprietary network (e.g. In the form of data synchronization). The external subject, however, has no access to this without the appropriate access authorization. In the case of a modification of the second configuration, the two applications, data flow control element and functional element, are not located in the same intranet, but in different hosts or intranets, which are coupled to each other via an open network (e.g., the Internet). In this case, the external subject communicates with the functional-element host by means of his browser over the Internet. In turn, the host communicates with the data flow control element in the proprietary network part over the Internet. The advantage of the second configuration (including the named modification) is the fact that the expenditure for software and data maintenance is reduced, but [information is] still secured, however, by the division into data flow control element and functional element, so that unauthorized external subjects only have access to the segment of data and functionality offered in the functional element. It is to be clearly noted with respect to the region of protection of the patent claims that in the case of the second configuration (including the named modification), the host that is located in the external subject plus the communication program (browser) and the network coupling the latter with the functional element does not belong to (or at least does not have to belong to) the device according to the claim.

According to the second aspect, the invention is directed to a device of the initially named type in which—as in the case of the first aspect of the invention—at least one attribute, which characterizes the event state in the course of the business process is assigned to the events, and which has at least one data flow control element for control of the data flows assigned to the events corresponding to the respective state of said at least one attribute. In addition, the device according to the second aspect has at least one automatic attribute status modifier, which automatically changes the status of said at least one attribute upon fulfilling one or more conditions, thus without the circumstance that a subject (e.g., a sales representative) has carried out a transaction in the business process (e.g., the disposition of a lead). The following will be noted for clarification of the significance of the term “automatic”: In general, a subject who participates in the business process cannot directly modify the status of the attribute, but rather makes communications specific to the system on his user interface (e.g. by clicking a soft button “dispose of lead”). This communication causes the application to correspondingly change the attribute status (here to set to “C” (closed)). Such a change in the attribute status conducted by the software based on a subject's input is not to be viewed as an “automatic change” in the sense of the second aspect of the invention.

The second aspect of the invention has the advantage, due to said at least partial automation of the change in attribute status to require less effort and to secure a more uniform conducting of the business process.

For specific application purposes, e.g., application in smaller companies, which do not operate together with external agencies or partner companies in the business process of interest here, the second aspect of the invention can be implemented advantageously in a computer or computer system without the division into proprietary and non-proprietary subnetworks and the application division resulting therefrom into data flow control element and functional element according to the first aspect of the invention. In other cases, in which there is a collaboration with such external subjects, it is, however, advantageous for achieving the automation advantages of the second aspect of the invention, to provide the latter with the first aspect of the invention and to optionally combine one or more of the configurations and embodiments named above or in the following.

Preferably, the automatic attribute status modifier is a timer. The latter changes the status of said at least one attribute preferably if a specific attribute status or one of several specific attribute statuses is present and a specific time has passed since an initial time point. It is conceivable that in special cases, the attribute status modification will be conducted after the expiration of the specific time for all attribute statuses present. The concept “specific attribute status” will thus also include “one or more specific attribute statuses” and “all possible attribute statuses”. For example, the time point of the generation of the event can be applied as the initial time point for the time interval which is the basis of the timer function. Alternatively, for example, the time point at which the present attribute status was assumed can be used as the initial time point.

However, let it be made clear that the modifications in attribute status according to the second aspect of the invention need in no way be conducted exclusively in automatic manner. Rather, the automatically modifiable attribute statuses are preferably also modifiable by manual intervention, each time before the condition for automatic change is entered. Preferably, one or more attribute statuses are also defined, which cannot be modified by the automatic attribute status. These are then manually modifiable—except for attributes that are generally not modifiable.

The invention also concerns corresponding methods and computer program products. In the case of the latter, these may involve, for example, a data medium for a data file containing a program code for execution on a data-processing system, which [file] can be transmitted over a network. With respect to advantageous configurations of the method and computer program product according to the invention, reference is made to the above statements relative to the devices for conducting the process.

### BRIEF DESCRIPTION OF THE DRAWINGS

Additional objectives, advantages and characteristics of the invention are indicated in subclaims as well as by the following description of examples of embodiment of the invention. Taken individually:

FIG. 1 shows an overview presentation of a first example of embodiment of a typical typical information network containing a device according to the invention;

FIG. 2 shows a block diagram of the data flow in an arrangement of a Web tool (LITE) and a Lead Information System (LIS) in the case of the first example of embodiment;

FIG. 3 shows a representation according to FIG. 1 of another example of embodiment;

FIG. 4 shows a representation according to FIG. 2 of the example of embodiment of FIG. 3;

FIG. 5 shows an illustration of the data flow during a synchronization of data between LITE and LIS according to the invention;

FIG. 6 shows a flow diagram representing a typical procedure in the data synchronization according to the invention, corresponding to FIG. 5;

FIG. 7 shows a block diagram analogous to FIG. 2 of a sample implementation of the first example of embodiment;

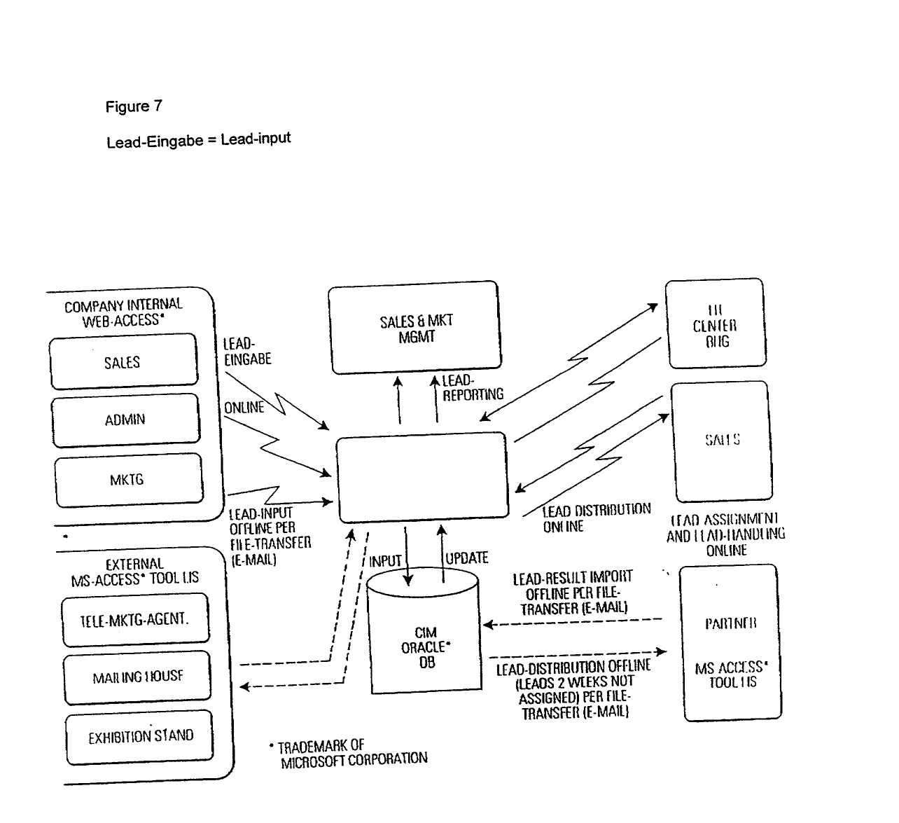

FIG. 8 shows a flow diagram representing the control of the flow of the business process on the basis of different attribute statuses;

FIG. 9 shows an example of embodiment of a lead entry input screen; and

FIG. 10 shows an example of the tables used in the relational database model in an overview representation.

### DETAILED DESCRIPTION OF THE INVENTION

In the figures, similar objects or objects that are equal in function are characterized in part with the same reference numbers.

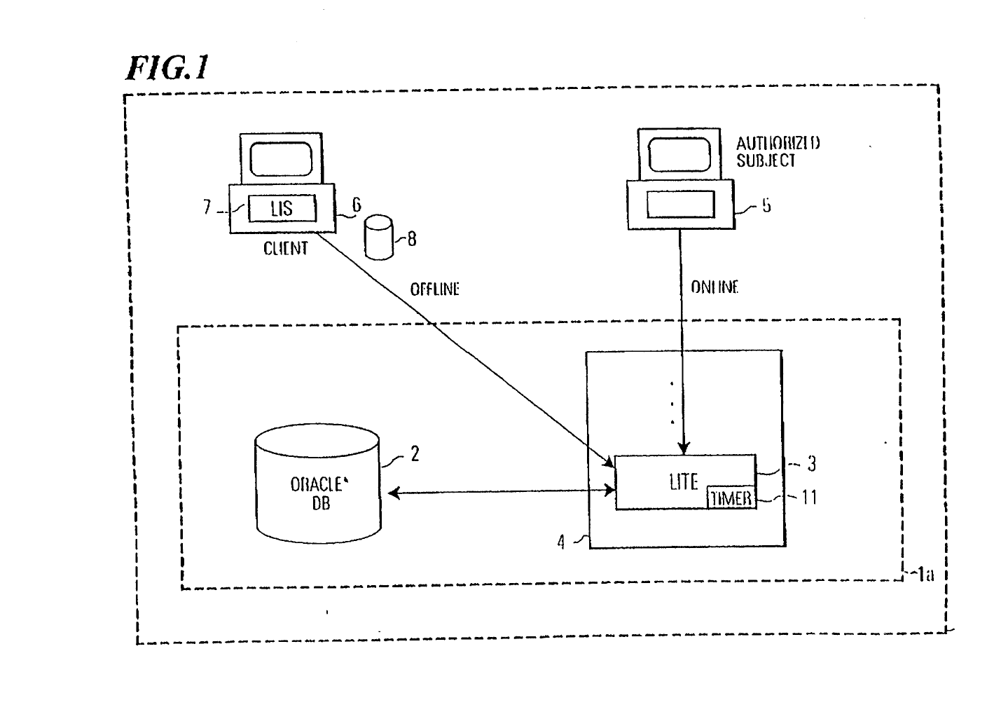

FIG. 1 displays a typical arrangement of data processing facilities in which the invention can be used. In particular, an information network 1 is shown with a system arrangement for conducting a business process according the invention. The arrangement shows a central database 2, which preferably has a relational data hierarchy and can be implemented, for example, by an “Oracle” database (“Oracle” is a registered trademark of the Oracle Company). This database 2 is arranged within a proprietary subnet 1a of the overall information network 1. It is emphasized that the proposed data flow control according to the invention can be executed on the Internet or in arbitrary extranets or intranets, which in the present context can be regarded as parts of a superordinated information network.

For the control of the data flow in an assumed business process, a hypertext-based data flow control element, a so-called Web tool 3 (Lead Information Tracking Environment=“LITE”) is provided, which is preferably installed on a Web server 4 located within the proprietary part of the overall information network. This tool 3 accesses database 2 and in particular controls the data flow between this database 2 and further instances and/or subjects involved in the business process, i.e., for example, natural persons or additional IT facilities such as personal computers or other facilities which allow for communication and interaction with LITE.

In the current example, one of the subjects 5 participating in the business progress represents a natural person, or a personal computer (PC) 5a assigned to this person, who (which) is authorized (“authorized subject”) to access the Web tool 3 online. This person may be a sales representative (SR) or manager, with appropriate access authorization, of the company that owns the proprietary subnet.

Another subject in this example represents a customer (“client”) 6 of the company, who is to initiate the cited business process with a purchase inquiry. “Customer 6” is to be understood as all subjects who can participate in the business process, without having access, however, to the Web tool 3 located in the proprietary subnet. For example, in addition to customer service partners and marketing agencies, this may also include customers themselves in the narrow sense. This customer 6 has available a functional element 7 (“LIS”), by means of which he can access the Web tool (LITE) 3 offline. The purchase inquiry is transferred to the tool 3 in the form of a file 8, whereby this file can, for example, be an attachment to an e-mail message. In any case, this communication takes place between the customer 6 and LITE 3 via the Internet. In general, the tool LITE 3 is located within the proprietary network la and the tool LIS 7 is external to the proprietary network. A timer module 11—whose function will be described below—is part of the LITE application 3.

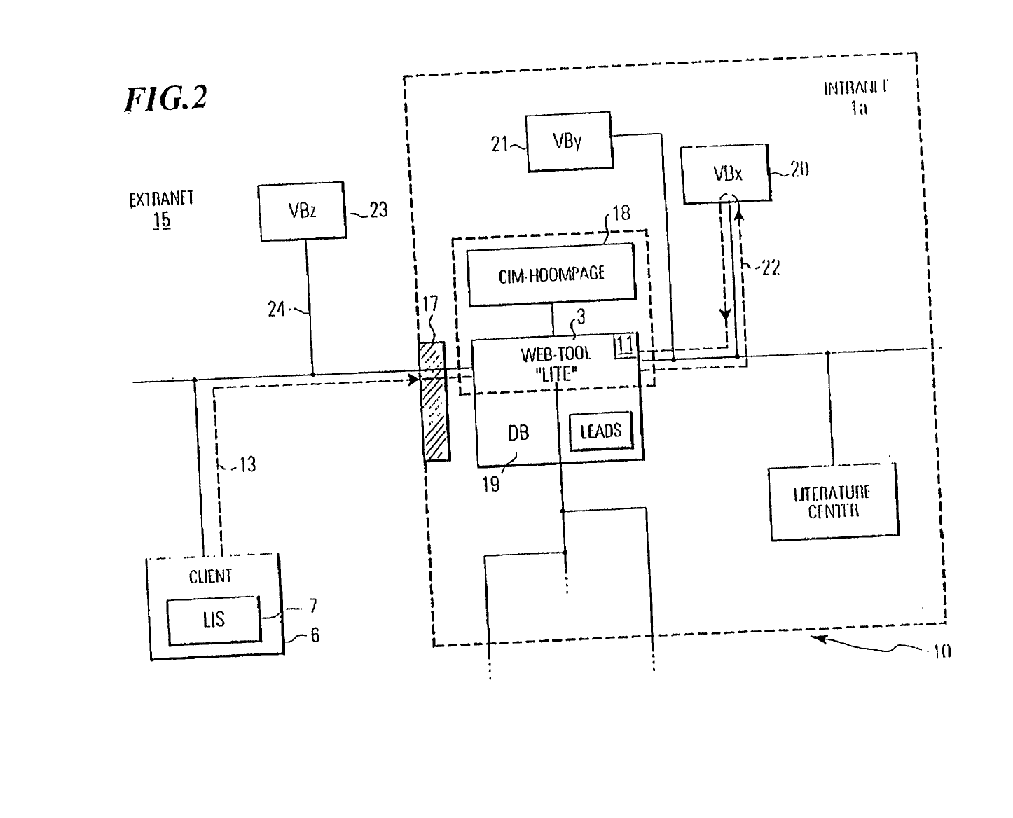

FIG. 2 shows a block diagram of the data flow in a sample arrangement 10 of a Web tool (LITE) 3 according to the invention as well as a Lead Information System (US) 7. In this example, the assumed business process starts with an inquiry 13 from a business customer 6, who in turn is already using the offline version of the data flow control element LITE, the functional element 7. For this purpose, both tools 11, 12 provide a data store, not shown here. In the present example as well, the inquiry is transferred to the Web tool LITE 3 as a so-called e-mail attachment. In the transition from the extranet 15 to the proprietary intranet 1a, this e-mail message passes a “firewall” 17 if provided.

In the sample embodiment, LITE 3 is implemented on a home page 18 of a customer information center (“CIM”). First of all, LITE 3 stores the inquiry in a central database 19. Via LITE 3, authorized persons (e.g., sales representatives SRx, SRy) 20, 21 can access database 2 online and, if necessary, accept further processing of the inquiry. In case of such an accepted assignment 22, for example, by one of the sales representatives (here “SRx”), the inquiry is appropriately designated by an attribute, not shown here, so that other persons authorized for access, for example a sales manager SRy 21, can learn of this assignment. Therefore, this attribute represents the respective lead status, by which certain business processes can be filtered out automatically using the respective statuses of the attribute. Additionally, the attribute allows for assignment of a lead to a certain subject (e.g. an SR), so that no other subject can process this lead (so-called “lead assignment”). It is further emphasized that online access is possible by an authorized subject accessing from within the proprietary network or from the outside (e.g., a sales representative SRz 23 interacting from the outside) by means of a telecommunications line 24.

The following attribute statuses or values are preferably taken into consideration for characterizing the status of a lead, and these are explained in more detail below:

O=lead is open;

A=(“assigned”) Lead has been taken on by an internal sales representative or lead was assigned to a sales representative by CIM (Customer Information Management), i.e., an administrator responsible for coordinating customer service); an automatic assignment is also possible;

C=(“closed”) Lead is closed;

W=Warning: Lead has not been assigned for two weeks;

E=(“exported”); the lead has been assigned to an outside sales partner;

P=Lead is open (ready) for assignment to outside partners;

T=Lead timeout, i.e., no lead processing is to be conducted any longer;

L=It is only necessary to provide literature.

In the database 2, the inquiry is now available in a data format that is uniform with respect to all persons involved in the business process. For example, if the inquiry is assigned to SRx 20 and thus bears attribute “A”, SRx 20 may begin with the processing of the inquiry. For this purpose, he generates 22, a copy of the existing inquiry file currently in central database 2 and processes this inquiry a by means of this copy. After the representative has completed this processing step, the modified file is transferred back again to the central database 2. The inquiry file has, so to speak, proceeded through a loop, whereby, in the process of subsequent processing steps, other such loops can follow or as a rule also will follow. Alternatively, the SR, the (SRx 20) can modify the data file within the scope of the processing directly in database 2. As has already been mentioned above, specific inquiries are assigned to an outside customer service partner, here “customer” 6. These involve inquiries with the attribute status “E”. Inquiry files with this attribute status are transferred from the data flow control element LITE 3 to the functional element LIS 7. After disposal, customer 6 receives the attribute status “C”, whereupon the modified inquiry file is again transferred back to LITE 3 and is stored in the central database 2 wherein the version of the inquiry file that has been present up to now, but is no longer current, is overwritten.

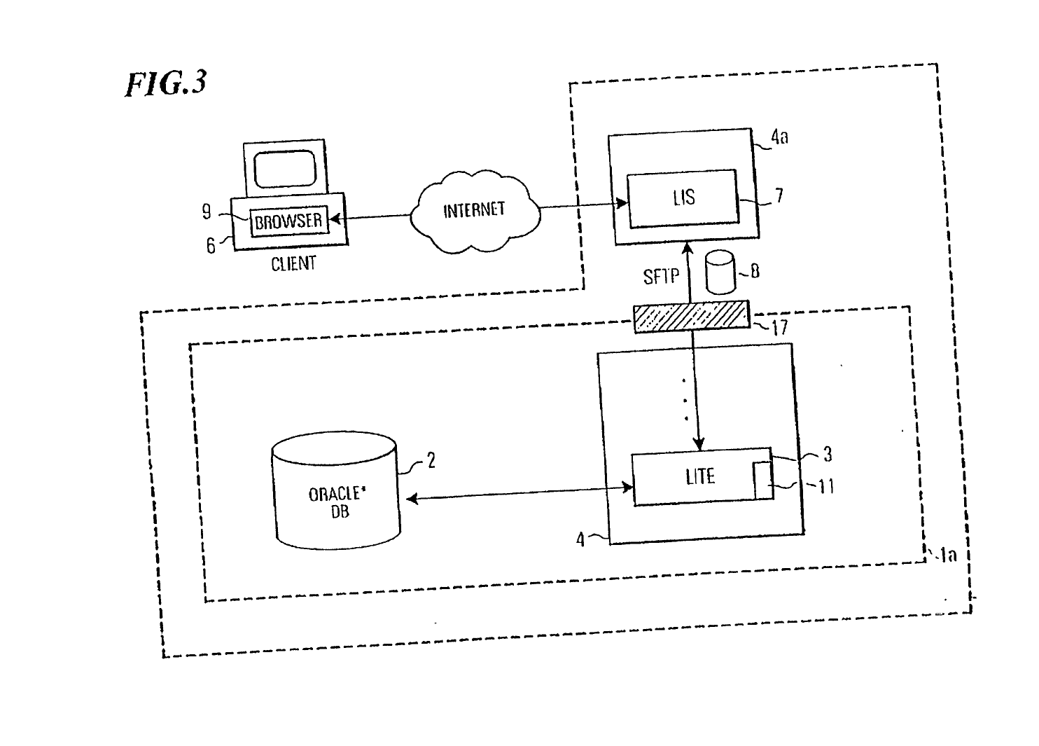

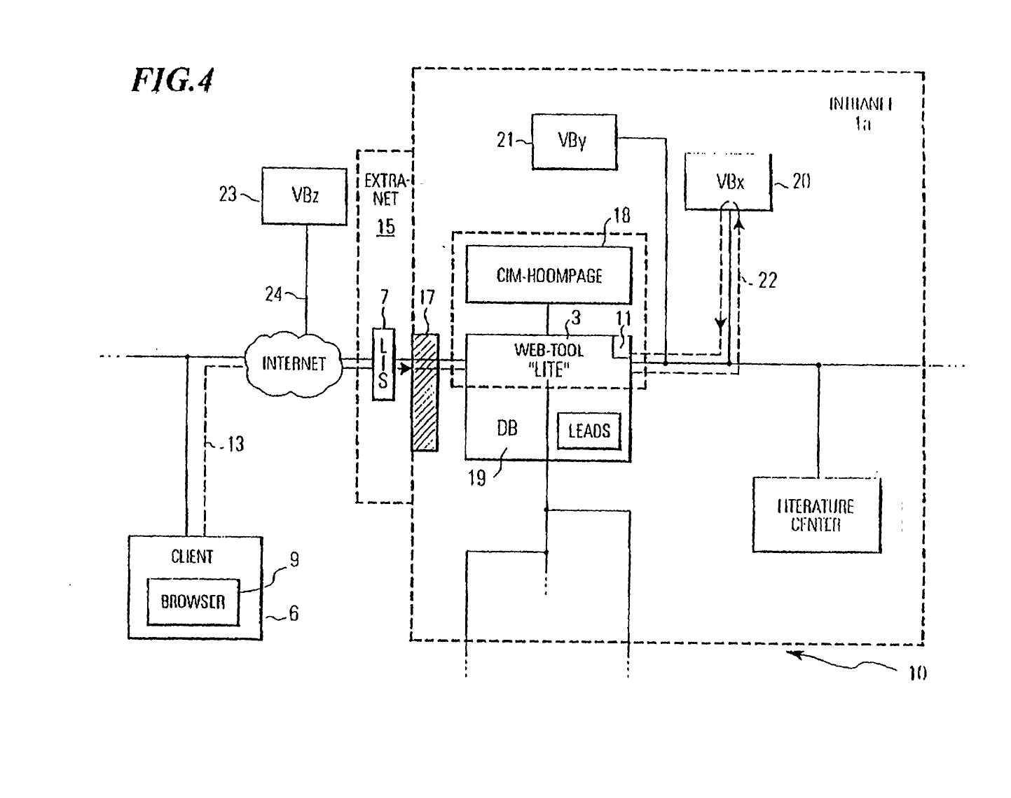

FIGS. 3 and 4 correspond to the views of FIGS. 1 and 2, but show another example of embodiment. And in fact, the functional element LIS here is not present each time on the side of customer 6, but runs only as a unique central application in the field of the company. LIS 7 is coupled to the internet by means of a Web server 4a. Instead of the LIS application, as in the case of FIGS. 1 and 2, a browser 9 runs on the side of the customer, with which the respective customer 6 can access central LIS 7 via the Internet and thus read inquiry data files specific for this purpose and can process this also, as the case may be. The connection between LIS 7 and LITE 3 (or between servers 4a and 4, on which applications 7 and 3 run) is a TCP/IP connection with a firewall 17 connected in between, which separates the proprietary subnet or the intranet 1a from the non-proprietary subnet or extranet 15. Only subjects with access authorization such as SRz 23 may access the LITE 3 via the Internet (FIG. 4). For synchronizing the data of LITE 3 and LIS 7, the data in data files 8 to be synchronized are transferred by SFTP (Secure File Transfer Protocol) between the two applications 3, 7. In the case of SFTP, the transfer of the data in a secure encrypted form, e.g., by application of a 40-bit secure encryption, is conducted by the SFTP. The file transfer is produced at fixed or variable time intervals, preferably once daily. In the case of other forms of embodiment (not shown), another timer module can be utilized for LITE application 3.

LITE 3 and LIS 7 are in applications described in HTML (Hypertext Markup Language) and ASP (Active Server Pages), which run on physically separated NT servers, namely the internal server 4 and the external server 4a. The LIS application 7 together with the database belonging to LIS 7 run on the external server 4a, while on the other hand, the database 2 belonging thereto does not run on internal server 4, but rather runs along with the DBMS (Data Bank Management System) on a special UNIX computer system. A CGI program (Common Gateway Interchange), which is written in Delphi provides for the synchronization of files assigned to LITE 3 and LIS 7.

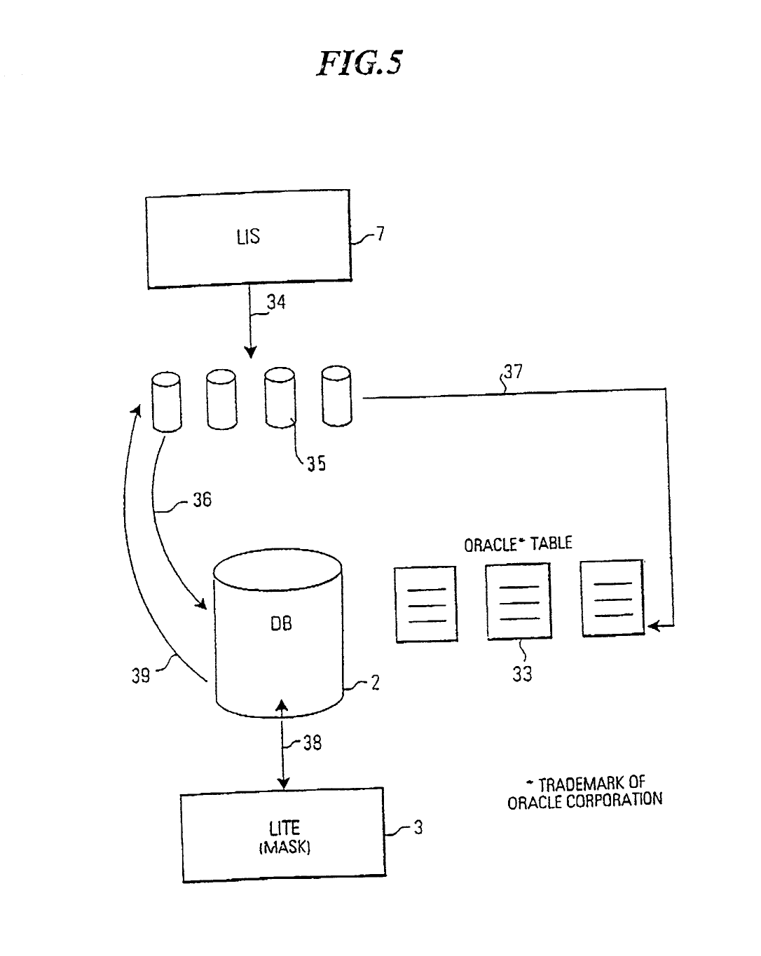

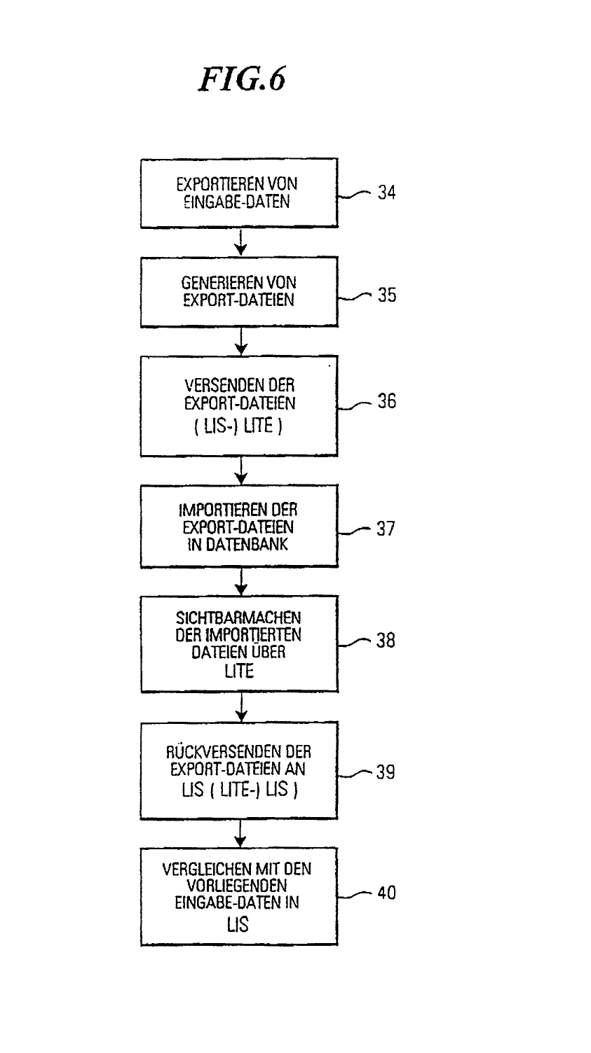

In FIG. 5, a typical data flow during data synchronization between LIS 7 and LITE 3 according to the invention is shown. First of all, LIS 7 serves to capture lead data initiating the respective business process and, for this purpose, contains initial data from LITE 3 as static copies (snapshots). Both applications 3, 7 serve for the completely autonomous flow control of the data flows occurring for a business process, wherein LITE 3 has the control priority. The procedure for synchronization includes the steps described below and named in the flow diagram shown in FIG. 6, wherein identical steps are provided with the same reference numbers. The synchronization is likewise based on the arrangement proposed according to the invention, which, among other items, provides a central database 2, in which the input data are stored in the form of tables 33, preferably Oracle tables. The synchronization process described here as an example concerns the case when the lead files initiating the respective business process are entered by an external customer. Other data synchronization procedures run in a similar way, in which, for example, data are issued by the external customer 6 to LIS 7 for purposes of conducting the business process.

First of all, the input data generated in LIS are exported 34 to LITE in the case of the present example, and the respective export files are generated 35, which can be sent 36, for example, via e-mail as attached file(s) or via FTP. These export files are now imported 37 into the database 32, wherein LITE 3 can carry out this import 37 totally autonomously and independent of any user input, using for example SQL statements (SQL =Structured Query Language). Here, the SQL statements allow for operations such as “INSERT” or “MODIFY”. Subsequently, the accordingly-modified Oracle tables can be displayed 38 by means of an input screen provided by LITE. It is emphasized that the structure or layout of the input screen is uniform for all persons involved in the business process. In the example shown, subsequently, copies of the export files 35 are re-transferred 39 to LIS, in order to be able to determine, by comparison 40 with the original input files, whether all files were transmitted without data loss in the original file transfer 36, since it is known that data loss can occur in transmission via the Internet. The synchronization is based on the fact that the data files to be modified in the course of the business process are provided with a “time stamp”, which gives the time point of the last modification and thus contains information on the current state of the file. The data files concerned may be stored already in the case of LITE 3 or database 2 and in the case of LIS 7. For synchronization, it is examined whether both versions possess the same current state. If this is not the case, the oldest version is overwritten by the current version, so that as a result of the synchronization, identical data files are stored in LITE 3 or database 2 and in LIS 7. In special cases, instead of the date stamp, an attribute hierarchy can decide whether the version of the LITE 3 or of the LIS 7 is to be given preference.

In the synchronization, data files may also be transferred, which are not present on the receiver side. In addition to the case of the first-time import of externally generated leads to LITE 3, which is shown in FIG. 6, it may also be the case, for example, if a lead conducted previously only in LITE 3 is placed on attribute status “E” and consequently is to be exported to LIS 7 and thus the respective customer 6 can access it.

Collisions are avoided in the synchronization process primarily by the fact that modifications of data concerning a business process must always be undertaken only either in LITE 3 with database 2 or in LIS 7. The question of which of the two sides should now conduct modifications of the data each time is decided by the respective attribute status. In special cases, if the modifications must be conducted both in LITE 3 and LIS 7, then an attribute hierarchy decides which of the two data versions is to be given preference over the others in the synchronization.

It is emphasized that the cooperation between LIS and LITE (thus how the data flows are controlled and on which side which modifications must be undertaken) is preferably exclusively done on the basis of the named attributes, which represent the respective lead status. The data flow control can be conducted completely automatically or autonomously by these attributes—particularly with the application of the timer function described in detail below.

In the course of the business process, the lead status is modified continuously on the basis of various actions. Correspondingly, the value of the attribute characterizing the lead status is also modified continuously. The following table indicates which initial attribute values are modified by which actions into which new attribute values:

| Initial lead status | | New lead status |
|---|---|---|
| (initial attribute value) | Action | (new attribute value) |
| A | closing of the lead | C |
| A | rejection of the lead by | O |
| | sales partner | |
| C | no modification possible | C |
| E | clouding of the lead by | C |
| | outside partner | |
| E | rejection of the lead by | W |
| | outside partner | |
| O | lead assignment to an | A |
| | internal sales | |
| | representative (e.g., by | |
| | the sales representative | |
| | himself or by CIM | |
| | (“internal assignment”) | |
| O | lead assignment to | E |
| | outside partner (“external | |
| | assignment”) | |
| O | lead is found 15 days in | W |
| | open status (“O”) without | |
| | internal or external | |
| | assignment | |
| W | lead is found for 5 days | P |
| | in the warning status | |
| | (“W”) without internal or | |
| | external assignment | |
| W | lead assignment to | E |
| | external partner | |
| W | lead assignment to sales | A |
| | partner | |
| L | no modification possible | L |
| P | lead assignment by | E |
| | external partner | |
| P | lead is found for 70 days | T |
| | in P status without | |
| | assignment by external | |
| | partner | |
| T | no modification possible | T |

The following remarks apply:

1. The status “E” will not indicate that the exporting of the lead has occurred successfully. Rather, the status “E” is made even when the lead is merely provided for exporting. Such a lead is then exported in the subsequent synchronization process, whereby it maintains its status up to the next change in status, e.g., based on a closed transaction by the external processing partner. “E” thus indicates that the lead is assigned to an external partner.

2. The attribute value defines which leads are transferred from LITE 3 to LIS 7 in the scope of the running synchronization and thus are made visible to external sales partners (or only to a specific external sales partner). This is the case for those with attribute values E and P.

3. Basically, collisions could occur, if attribute values could be modified simultaneously on the side of both LITE 3 and LIS 7. Such collisions are excluded primarily by the fact that leads on the side of LIS 7 can only be modified if the attribute has the value E or P. In this case, no modifications of the lead and of the attribute can be conducted on the side of the LITE 3. In special cases, modifications must be conducted both in LITE 3 and LIS 7; for example, a timer can set the “P” status to “T” in LITE 3, whereas the P status can be set to “E” in LIS 7. In such a case, an attribute hierarchy decides which of the two file versions is given preference relative to the other in the synchronization. In the named example, the E status in the hierarchy is superimposed on the T status; thus, in the synchronization, the version of the lead that is stored by LITE 3 will be replaced by that for LIS 7 and the T status is again eliminated.

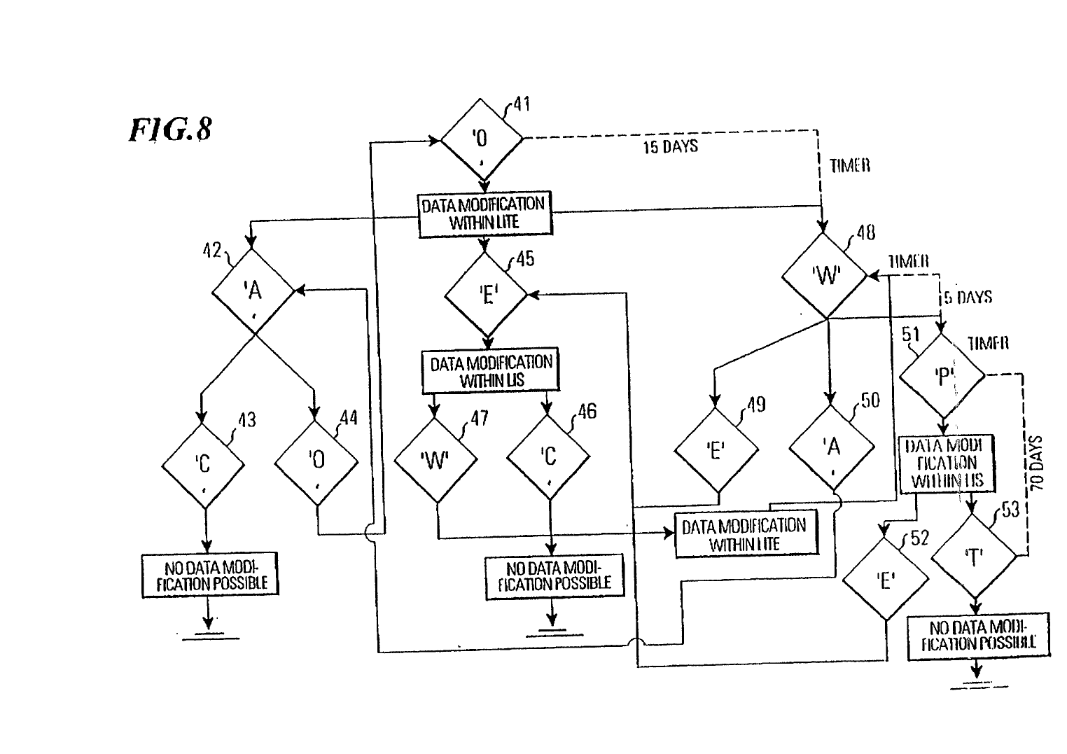

The control of a business process run based on the different lead statuses and the attribute values characterizing these is illustrated in FIG. 8. It should be made clear that FIG. 8 concerns the processing of a single lead. The various reference numbers stand for different stations, which one and the same lead can pass through in the business process. The initial point is a newly generated lead 41, which may have been produced, for example, on the basis of a customer inquiry internal to the company or by an external sales partner. New leads automatically receive the attribute value “O”. Leads with the attribute value “O” and thus the lead at 41—may be modified only within LITE 3 and are preferably also only visible within LITE 3. The sales representatives of the company may view the lead at 41, on the other hand, and they can assign it to themselves or it can be assigned by an administrator. An automatic assignment is also possible, if all inquiries of a certain type can be assigned to the sales representative responsible each time for the region he represents, depending on the region where the lead originates. As a consequence of the assignment process, the lead receives the attribute value “A” at 42. Like all leads with the status “A”, the lead at 42 can be modified only on the side of LITE 3—and in fact is now limited to the sales representative according to the assignment—and will be observed now, just as previously, only in LITE 3. The sales representative can then process the lead, whereupon, after entry of an appropriate note that the transaction is concluded, the lead receives the attribute value “C” at 43. From this moment on, data modification is no longer possible, and the process is concluded. Alternatively, the sales representative can refuse to take the lead. By entry of a corresponding note of refusal at 44, the lead again receives the initial status “O” and is further available to the business process, just like a newly generated lead 41.

The administrator, however, can also decide that lead 41 will be processed by a specific external sales partner, whereby the attribute value is placed at 45 to “E” upon an appropriate entry. It is also possible that this decision is made automatically without intervention of the administrator, e.g., based on the nature of the customer inquiry. Leads with the attribute value “E”—and thus also the lead at 45—are visible after the synchronization step on the side of LIS 7 at least for the corresponding external sales partner and can be modified also only by the latter right after the status to “E” is made. The external sales partner can now either accept or decline the assignment of lead 45. In the first case, he will dispose of the lead, after which it receives the attribute value “C” after entry of an appropriate disposal at 46. A modification of the data is then no longer possible, and the process is closed. In the case of a refusal of the assignment, the lead obtains the attribute value “W” after entry of an appropriate rejection note by the external sales partner at 47. With status “W”, a data modification is still only possible within LITE 3, so that lead 47 is then further processed as a lead at 48, which has received the status “W” in another way (see below).

If the original lead 41 still has (or again has) the attribute value “O” after expiration of a specific first time interval (e.g., 15 days), then it automatically obtains the attribute value “W” by a first timer (15-day timer) at 48. Leads 48 with the attribute value “W” (the previously mentioned leads rejected by an external partner at 47 are also included in this category) can be assigned by the administrator to an external sales partner and obtain the attribute value “E” after a corresponding assignment entry at 49. If an external sales partner has already refused to accept the lead, the refusal is preferably routed to another external sales partner. The lead 49 with the status “E” is further processed just like the lead at 45. Alternatively, an internal sales representative can assign to himself the lead 48 with the status “W” or it can be assigned by the administrator. After entry of an appropriate assignment entry at 50, the lead receives the attribute value “A” in this case and is further processed like the lead at 42. If lead 48 still has (or again has) the attribute value “W” at the expiration of a second time interval (e.g., five days), the attribute value will be set automatically to “P” at 51 by a second timer (five-day timer). The lead is now visible in LIS 7 and can only be modified therein. One of the external sales partners can now be assigned the lead, wherein it receives the attribute value “E” by a corresponding assignment entry at 52. It is then further processed as at 45. If the lead still has (or again has) P status after the expiration of a third time interval (e.g., 70 days), it receives the attribute status “T” by a third timer (70-day timer) automatically at 53. From this moment on, data modification is no longer possible in the normal case, and the process is considered closed due to the time expiration. Only in the above-mentioned special case, in which it has received the status “E” during the last synchronization process on the part of the LIS, is the T status removed again on the basis of the above-mentioned attribute hierarchy and uniformly set to “E” in LIS and LITE.

There are different possibilities for the definition of the timer. One possibility consists of the fact that each time the time point is selected when the lead receives the respective status to be monitored, as the initial time point of the time interval to be monitored by the respective timer. For the first timer, this would be the time point at which the lead is generated; for the second timer, this would be the time point at which the lead receives the status “W” at 47 or 48; and for the third timer, this would be the time point at which the lead receives the status “P” at 51. Another preferred possibility consists of the fact that a common initial time point is the basis for all timers, which is independent of the respective course of the business process. Preferably, this is the time point at which the lead was generated. The timers examine daily the entry date (field “ENTRY_DATE” in table LLLO, see below) and calculate:

expired time interval=current date−entry date.

The first timer investigates whether the expired time interval is already longer than the first timer time interval (15 days); the second timer investigates whether the expired time interval is already longer than the sum of the first and second timer time intervals (15 days+5 days=20 days); and the third timer investigates whether the expired time interval is already longer than the sum of the first, second and third timer intervals (15 days+5 days+70 days=90 days). In the case of the several timers that have been named, these involve a functionally motivated concept selection. In the technical program, the several timers can be formed by a single counter and subtraction device (as indicated above), in which the determined time difference is subjected to several condition inquiries. The timers are preferably parts of a timer module for LITE application 3. However, it is also possible that only the first and second timers are located in LITE application 3, and on the other hand, the third timer is found in LIS application 7. In this case, the aforementioned simultaneous conversion of the P status to “E” and “T” is not possible, so that the mentioned attribute hierarchy is not necessary.

Finally, it should be mentioned that different timer definitions can also be the basis for different lead categories. For example, for leads, which belong to a specific field of the company or to a specific inquiry category, longer or shorter time intervals will be used than for other leads.

Additional details of LITE 3 and LIS 7 will now be described in the following. The description is thus divided into a description of the proposed functionality of a data flow control element (Web tool designated as “LITE”) according to the invention as well as a corresponding description of a functional element according to the invention with the designation “LIS”.

### Description of the Web Tool “LITE”

### Main Menu

The main menu of LITE consists of the following functions described subsequently in more detail: “Lead Entry”, “Lead Overview”, “Lead Processing”, “Lead Reporting”, and “Admin”.

### Lead Entry

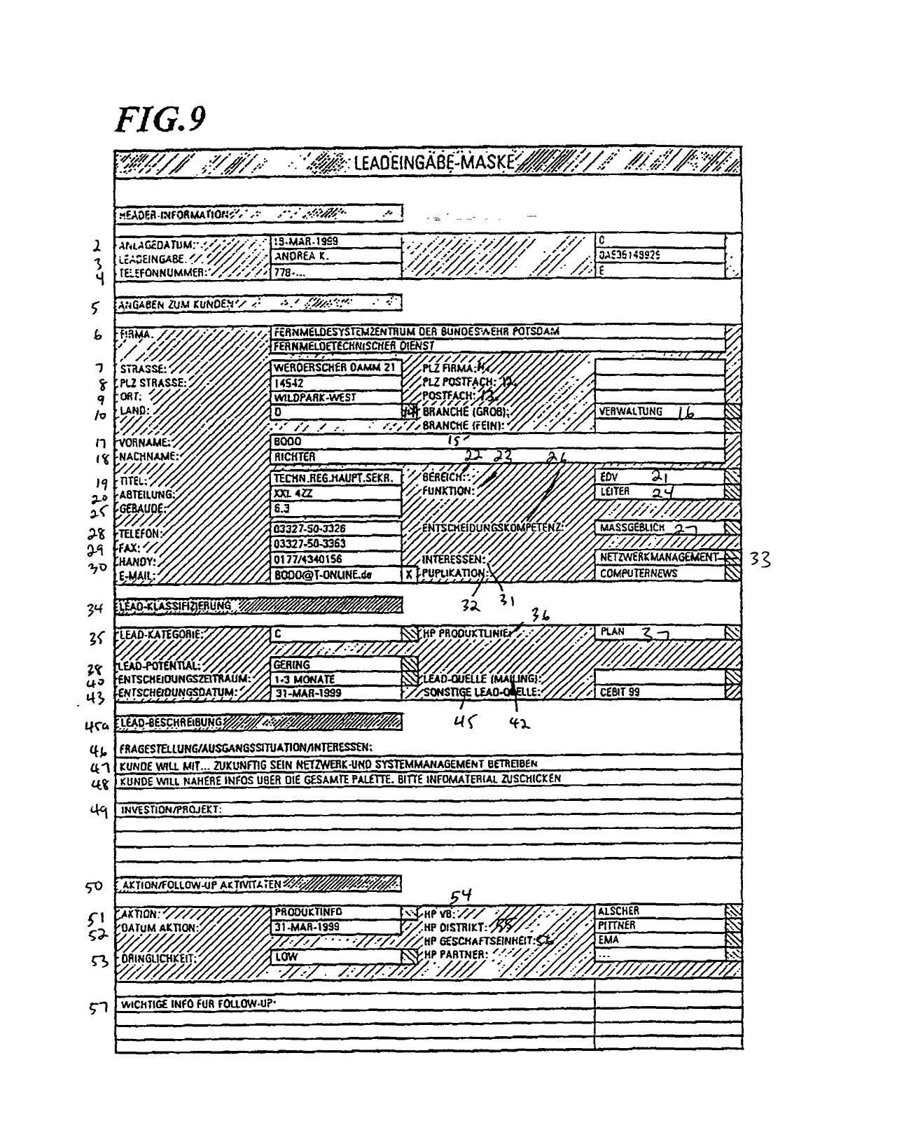

A lead is entered by means of a lead entry screen. At this point, it is possible to assign the lead to a responsible sales representative (SR). A corresponding lead entry screen of tie data flow control element “LITE” is shown in FIG. 9.

### Lead Overview

With this functionality of the Web tool, the leads entered can be displayed in summary form. With a search function, the leads to be displayed can also be defined. By default, all open leads are displayed. The leads are displayed in a list, one after the other. The details of a particular lead can be viewed, and the sales representative can assign the lead to himself if he is responsible for it.

### Lead Processing

The functionality of “Lead Processing” is comparable to the function “Lead Overview”. The difference is that a list is displayed of only all those leads assigned personally to the sales representative. With a search function, a sales representative can easily obtain an overview of his personal leads. This function is not displayed for all subjects (here persons or users) taking part in the underlying business process with a manager entry of “UNKNOWN”.

### Lead Reporting

This function contains a menu choice for general, pre-defined lead tracking statistics. These statistics are to provide a quick overview of lead tracking activities to the users as well as to management.

### Admin

All administrative functions can be performed here. The import from “LIS”-generated lead files from agencies is possible, as well as the export and import of LIS files from respective business partners.

In the following, the functions are described in detail in appropriately named sections.

### Lead Entry

The lead entry screen consists of a form structured as follows:

Header Information
Customer Information
Lead Classification
Lead Description
Action / Follow-up Activities
a) Header Information
The fields consist of:

| | |
|---|---|
| Date of entry | = System date |
| Lead entry performed by: | Name of person making the entry |
| | Display not possible until Lead Detail screen |
| Telephone number of | Display not possible until Lead Detail screen |
| person making lead entry | |
| Organization of person | Display not possible until Lead Detail screen |
| making lead entry | |
| Lead Status | Automatically “O¹⁰ for “open” |
| Lead ID | Display not possible until Lead Detail screen |
| b) Customer Information | |
| The fields consist of: | |
| ba.) Company | |
| Company | (required) |
| Street | (required, optional if entry in post office box) |
| ZIP (street) | (required, optional if entry in post office box) |
| Post office box | (optional) |
| ZIP | (optional) |
| (post office box) | |
| ZIP (company) | (optional) |
| City | (required) |
| Country | (required, menu choice, default value: ‘D’) |

bb.) Sector (optional, menu choice, only one sector selectable)
The following sector-related fields can be selected:
1. Sector (general), (required, menu choice)
Industry
Banking/insurance
Wholesale/retail trade
Telecommunications
Transportation
Government
Education
Unknown
2. Sector (detail), (optional, menu choice)
This sector information serves as an addition for later selections.
bc.) Customer
First name (optional)
Last name (required)
Title (optional)
Department (optional)
Building (optional)
Functional area (required, menu choice)
Position (required, menu choice)
Phone (optional)
Fax (optional)
Cell (mobile) phone (optional)
e-mail (optional)
bd) Decision authority (optional, menu choice)

The following decision authority values can be selected:

Sole authority

Plays major role

Recommends

Provides information

be.) Fields of interest (optional, menu choice)

Fields of interest can be, for example, the various product segments of a company.

bf) Publications (optional, menu choice)

The following publications can be selected, among others:

Computernews

c) Lead Classification

Lead Classification has the following fields:

Lead potential (required, menu choice)

| | |
|---|---|
| High | (A lead) |
| Medium | (B lead) |
| Low | (C lead) |
| Unknown | (D lead) |
| Lead category | |

By checking the lead potential, the lead category will be defined automatically (see above assignments). This will be displayed separately by the lead screen.

Decision time (optional, menu choice)

Less than 1 month

1-3 months

3-6 months

More than 6 months

Decision date

Product line (optional, up to three designations possible, menu choice)

Lead source (required, menu choice, free-form text also possible if clear and uniform abbreviations are used)

d) Lead Description

The fields consist of:

Question/Current Situation/Interests (free-form)

Investment/Project (free-form)

e) Action/Follow-up Activities:

The fields in the Follow-up Activities area consist of:

Action (required, menu choice)

Call back

Offer

Demo at customer location

Product info

Support required

Date of action (optional)

When the field “Product info” is checked, an additional window will be displayed. The clickable fields with a menu choice are, for example, the following:

Data Center

Technical Computing

Electronic Commerce & Electronic Business

IT Service Management

Office Computing / Printing Solutions

Information Storage

If the user clicks the Data Center entry, for example, a pull-down menu appears containing literature to check (for instance, Enterprise Servers). If anything within this screen is checked when storing the lead, a message to the e-mail account of a literature center is automatically generated, citing the applicable lead. The literature center can then begin responding to the request. Additionally, there is a free-form field for all literature requests that cannot be chosen from the menu.

Urgency (required, menu choice)

High

Medium

Low

Sales representative (SR)

If “Contact” is clicked, the-user has to make a choice between “manual assignment” and “automatic assignment”. If automatic assignment is clicked, an online search is made of a customer information database (CIM) for entries similar to that contained in the Company field. The result, showing which sales representatives are proposed, is displayed. The user must choose one alternative. When a sales representative is chosen, that representative's manager is automatically entered into the district field. If nothing is found, the message “No assignment possible” is displayed. In a manual assignment, the sales representative is known to the user, and the representative can be clicked in a menu choice. The district entry is generated automatically.

District

According to the choice in the Sector field, the correct district manager is displayed automatically. If several districts are possible, the reader is prompted to click the correct one. If the company is assigned via the Sales Representative item, this district entry has priority.

Business Partner (optional, menu choice)

Here, the user can decide which partner is to handle the lead.

Important Info for Follow up/Notes (free-form)

Additional information can be entered here.

The lead is completed using the SAVE button. All entries are saved and the company as well as the contact are designated with the data source “LEAD”. A prompt is issued for entering another lead. Otherwise, control passes automatically to the main menu.

### Lead Overview

In the menu item “Lead Overview”, lead lists can be generated and displayed using search criteria. Search criteria can be defined via a pull-down menu and searches performed via the “SEARCH” button.

Search criteria are:

Lead category (“A”, “B”, “C”, or “D”)

Urgency

Lead status (according to default setting, initialized with status “O”)

Field of interest

Product line

Sector

Company name (entry of wildcards is required)

Postal code (at most 5 ZIP ranges possible, e.g., 50000 to 60000 is one code range)

Publication, Decision time, Lead source, Action, Sales representative, District,

Business unit, Partner

Logical “AND” or “OR” operations are possible within the search criteria. Saving of one set of search criteria per user is possible.

The individual lead list is prepared. The information per line (=one lead) from left to right is the following:

Lead status

Lead category

Urgency

Company

City

Sales Representative (if available, else empty field)

District (if available, else empty field)

With a mouse click (cascade), a lead can be chosen and the detailed information of the respective lead can be viewed (see input screen—detail screen). Leads can only be changed and/or deleted in the lead detail screen. Changing or deleting a lead is only possible for the person entering it (see also the authorization scheme described below). Deletion is only logical, however. The lead list and details of the leads can be printed accordingly. In summary, the procedure is as follows:

Define lead list with search criteria

Press Search button, lead list is displayed

View lead detail (with mouse click)

Within the lead detail screen, a sales representative can assign the lead to himself via the button “Assign Lead” and “lock” it exclusively for himself (see the authorization scheme described below). A lead assignment is possible only for an open lead (status “O”), however. The status of the lead then automatically becomes “A”. The lead is now locked and cannot be assigned to another person. This lead is now visible in “Lead Processing” as described above and can be processed there further by the sales representative (Info Window for User display).

For example, an e-mail message is automatically generated each week to the district managers with the list of all open leads that are not assigned to a district (no lead details, just overview list). (The mailing list can be defined by administration). The open leads that are already assigned to a district are sent to the respective manager. The manager is requested therein to inform his sales representatives accordingly of the leads.

### Lead Processing

“Lead Processing” is, so to speak, the private working area of the sales representative. By default, he sees all leads assigned to his login in the overview list. In its layout, the lead detail screen corresponds to that of the entry screen. The lead can be closed either with a “Lead Closure” screen or without setting up a business project (“Close Lead” button). The sales representative has processed the lead. At the same time, the SR can enter the following information into the closure screen.

No revenue (checkable)

Revenue in K$ (required if “No revenue” was not checked)

EXIT remark (required)

The status of the lead becomes “C” and can no longer be modified. Alternatively, the lead can be converted into a business project (“Project” button). In the detail screen, all transferred data are disabled. Only the project name need be entered as additional information. After confirming with the “SAVE” button, the lead is converted into project. This creates a new project under his login (company assignment). To do so, the sales representative gets an information window to continue the lead as a project and to supply missing data. The status of the lead becomes “C” and can no longer be modified.

As another variant, there is a possibility that the sales representative will reject the lead, for example due to lack of time or interest for handling the lead himself. He rejects it and indicates the reason for the rejection. The lead again assumes the Open status.

### Lead Reporting

Under the menu item Lead Reporting, the user can choose and view certain statistics. These predefined statistics are as follows:

Number of leads, grouped by category, urgency and status

Number of open leads, grouped by

Lead category

Urgency

Sector

Field of interest

Product line

Number of assigned leads, grouped by sales representative, district

Number of leads converted to projects, grouped by sales representative, manager, and project status.

Total revenue generated by leads, grouped by sales representative, manager

Overview list of all leads ready to be transmitted to HP partners. This list is generated via the Admin function.

All statistics can be displayed individually, both numerically in tabular form and as graphics.

### Admin

This function can be used only by the administrator. As described in the section “Lead Overview”, the mailing list for the district managers can be generated here as well.

Furthermore, in this function a list of all open leads older than a selectable period of time from the entry date can be generated. These leads are ready for transmission to a partner for handling in “LIS”.

The generation of a lead list in overview uniform can done via the button “EXPORT List”. This lead list can be viewed by sales management under Lead Reporting prior to sending in order to possibly remove specific leads. The sales organization informed briefly by e-mail, to request removal from the central database within a few days. After expiration of this removal time limit, all respective leads are set to status “E” by action on the “EXPORT” button.

All leads which are to be handled by a literature center, are set to “L”. With the Literature Export button, an appropriate file is generated that can be read by the literature processing software “Click”.

### Description of the functional element

1. Example of embodiment: The Microsoft Access-based tool LIS (=Lead Information System) is an offline version of LITE. (“MS ACCESS” is a registered trademark of the Microsoft Corporation). A prerequisite for the installation of LIS in the present case is Microsoft Access 47. Basically, however, the same or similar database systems can be considered. LIS is a standalone application that is installable via a simple routine. LIS is delivered to external agencies and partners in the MS Access run-time version.

2. Example of embodiment: The functional element LIS is a central application in the field of the company, on which external agencies and partners can intervene with the help of a browser via the Internet.

The purpose of LIS is to be able to register lead data externally, for example from agencies, and transmit it as files to the company via e-mail or by FTP. These leads can be imported into LITE and handled there. The lead files thus processed by the partner companies (all leads present in LIS) are returned to LITE via e-mail or FTP, where they can be imported.

LIS is password-protected via a uniform login procedure. The layout of LIS is based entirely on LITE, with respect to both functionality and design. Because there is no online access from LIS to LITE, all tables needed (e.g. menu tables) are copied into LIS as snapshots. An update can easily be performed from time to time (first example of embodiment) or is automatically conducted, e.g., in fixed time intervals (e.g., daily) (second example of embodiment). In accordance with the LITE design, LIS can import or export the lead files by means of an export-import function. The data model (tables) of LIS corresponds to that of LITE.

### Data Model

In the following, an overview is given of the tables used in the relational database model. After that, the details of a so-called “lead tracking table” are described. In the following, the tables for the entry fields provided for LITE and/or LIS are described first.

Lead Entry
Header information

| | |
|---|---|
| Entry date | LLLO ENTRY_DATE |
| Lead entered by | XUS0. USER_NAME |
| Phone number | XUS0. PHONE_NO (new, char (16)) |
| Organization | XUS0. ORGANISATION (new, char (3)) |
| Lead status | LLL0. LEAD_STATE |
| Lead ID | LLL0. PKEY |

Customer data

| | | |
|---|---|---|
| ba) | Company | |
| | Company name | SSS0. COMP_NAME1, SSS0., |
| | | COMP_NAME2 |
| | Street | ADR0. STREET_NO |
| | ZIP (street) | ADR0. ZIP_STR |
| | Post office box | ADR0. POSTBOX |
| | ZIP (post office box) | ADR0. ZIP_PB |
| | ZIP (company) | ADR0. ZIP_COMP |
| | City | ADR0. CITY |
| | Country | ADR0. COUNTRY_CD |
| | Data source | SSS0. DATA_SOURCE = “LEAD” |
| bb.) | Sector | |
| | Sector | SSS0. INDUST_CD1 |
| bc.) | Customer | |
| | First name | APR0. FIRST_NAME |
| | Last name | APR0. LAST_NAME |
| | Division | APR0. DIVISION |
| | Building | ADR0. BUILDING |
| | Title | APR0). TITLE |
| | Department | APX0). DEP_CD |
| | Function | APX0. FUNC. CD |
| | Phone | APR0. PHONE |
| | Mobile phone | AFR0. PHONE_CAR |
| | Fax | APR0. FAX |
| | e-mail_OK | AFR0. EMAIL_OK |
| | Data source | APR0. DATA_SOURCE = “LEAD” |
| bd.) | Decision authority | |
| | Decision authority | APR0. DECISION_FUNC (new, |
| | | char (25)) |
| be.) | Fields of interest | |
| | Field of interest | APS0. FOI_S |
| bf.) | Publications | |
| | Publication | APM0. STDMAIL_CD |

Lead classification

| | | |
|---|---|---|
| | Lead category | LLL0. LEAD_CATEGORY |
| | Lead potential | LLL0. POTENTIAL |
| | Decision time | LLL0. DECISION_TIME |
| | Decision date | LLL0. DECISION_DATE |
| | Product line | LPL0 |
| | Lead source | LLL0. LEAD_SRC |
| d.) | Lead description | |
| | Question | LLL0. LEAD_QUESTION |
| | Investment | LLL0. LEAD_INVESTMENT |
| e.) | Follow-Up Activities | |
| | Action | LLL0. ACTION |
| | Action Date | LLL0. ACTION_DATE |
| | Product Info | LIT0 |
| | | LLL0. LIT_FREETEXT |
| | Urgency | LLL0. URGENCY |
| | SR | LLL0. SR |
| | District | LLL0. DISTRICT |
| | Business unit | LLL0. BU_CD |
| | Partner | LLL0. PARTNER |
| | Important information | LLL0. LEAD_FOLLOWUP |

### References to the Menu Table XTG0

In this section, the references of the menu choice values to the menu table XTG0 are described.

Lead entry

| | | |
|---|---|---|
| a.) | Header Information | |
| | Organization | XTG0. FELD_ID = 20.000 |
| | | ][FELD = field] |
| b) | Customer data | |
| | Country | XTG0. FELD_ID = 12.000 |
| bb.) | Sectors: | |
| | Sector (general) | XTG0. FELD_ID = 27.000 |
| | Sector (detailed) | XTG0. FELD_ID = 10.800, |
| | | BU_CD EAO |
| bc.) | Customer | |
| | Department | XTG0. FELD_ID = 18.000 |
| | Function | XTG0. FELD_ID = 17.000 |
| bd.) | Decision authority | |
| | Decision authority | XTG0. FELD_ID = 21.000 |
| be.) | Fields of interest | |
| | Field of interest | XTG0. FELD ID = 15.000, |
| | | BU_CD = EAO |
| bf.) | Publications | |
| | Publication | XTG0. FELD_ID = I 4.000 |
| c.) | Lead classification | |
| | Lead potential | XTG0. FIELD_ID = 22.000 |
| | Decision time | XTG0. FIELD_ID = 23.000 |
| | Product line | XTG0. FIELD_ID = 40.100, |
| | | BU_CD = EAO |
| | Lead source | RCA1. CAMP_CD, with END_DATE = |
| | | SYSDATE-3 months (all campaigns of the |
| | | last quarter are displayed), CAMP_DESC |
| | | is displayed |
| e.) | Follow-Up Activities | |
| | Action | XTG0. FELD_ID = 24.000 |
| | Product info | XTG0. FELD_ID = 24.100 |
| | Literature | XTG0. FELD_ID = 24.200 |
| | Urgency | X7-G0. FELD_ID = 25.000 |
| | Partner | XTG0. FELD_ID = 10.300 |
| | District | XTG0. FELD_ID = 26.000 |
| | Business unit | XTG0. FELD_ID = 20.000 |

(Entry either via manual/automatic sales representative assignment or by default XTG0. Field_ID=27.000)

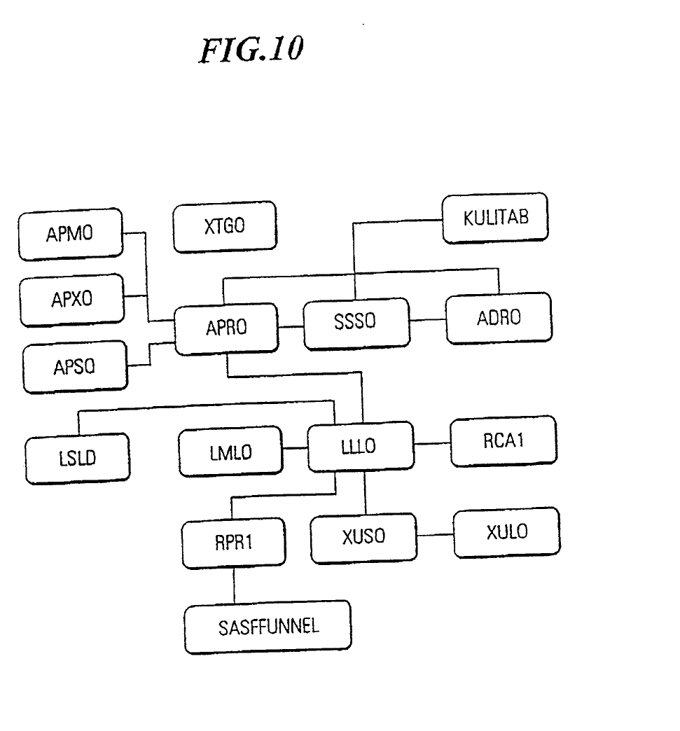

A relational database model according to the invention is shown in FIG. 10 on the basis of an tabular overview. The abbreviations used are explained on the basis of the following key:

Key to Table Abbreviations:

| | | |
|---|---|---|
| ADR0 | = | Address table |
| APM0 | = | Publications table |
| APR0 | = | Point of contact table |
| ARS0 | = | Standard [default] interests table |
| APX0 | = | Matrix (function/department) table |
| LIT0 | = | Product information table |
| LLL0 | = | Lead detail table |
| LML0 | = | Mailing table |
| LPL0 | = | Product line table |
| LSL0 | = | Lead search table |
| RCA1 | = | Campaign description table |
| RPR1 | = | Project table |
| SSS0 | = | Work locations table |
| XTG0 | = | Toggle table |
| XUL0 | = | DB user table core data |
| XUS0 | = | DB user table |
| KULITAB | = | Customer list table |
| SASFFUNNEL | = | Product line project table |

In the following, a sample embodiment of a table used in the database model (lead tracking table) is described in detail:

TABLE LLL0

| | | |
|---|---|---|
| create table LLLO | | |
| (STATUS | CHAR(I), | -Record status (by default ‘0’, |
| | | logically deleted ‘9’) |
| MODIFIED | CHAR(8), | - Lead modification date |
| PKEY | CHAR(11), | -Lead ID |
| EX_DATE | DATE, | -Export date |
| ENTRY_DATE | DATE, | - Lead entry date |
| CLOSE_DATE | DATE, | - Lead close date |
| ASSIGNED_DATE | DATE, | - Lead assignment date |
| PROJEKT_DATE | DATE, | - Lead project date |
| LEAD_STATE | CHAR(1), | - Lead state |
| LEAD_SRC | CHAR(10), | - Lead Source. |
| LEAD_SRC_MAIL | CHAR(10), | - Lead Source |
| LEAD_CATEGORY | CHAR(1), | -Lead catcgory |
| POTENTIAL | CHAR(11), | - Lead potential |
| DECISION_TIME | CHAR (11), | - Decision time |
| DECISION_DATE | DATE, | - Decision date |
| CALL_BACK | CHAR(1), | - Call back |
| DEMO | CHAR(1), | - Demonstration |
| OFFER | CHAR(1), | - Offer |
| PRODUCT_INFO | CHAR(1), | -Product information |
| SUPPORT | CHAR(1), | - Support |
| CALL_BACK_DT | DATE, | -Call back date |
| DEMO_DT | DATE, | - Demonstration date |
| OFFER_DT | DATE, | -Offer date |
| PRODUCT_DT | DATE, | - Product information date |
| INFO_DT | DATE, | -Support date |
| LIT_FREETEXT | CHAR(30), | - Free text field literature |
| | | request |
| URGENCY | CHAR(6), | - Urgency |
| SR | CHAR(30), | - Sales representative |
| DISTRICT | CHAR(14), | - District manager |
| BU_CD | CHAR(3), | - Business unit |
| PARTNER | CHAR(30), | - Partner |
| REVENUE | NUMBER(10), | - Total revenue |
| EXIT | VARCHAR(255), | - Exit remark |
| RPRPKEY | CHAR(11), | -Join APRO |
| APRPKEY | CHAR(11), | -Join APRO |
| RCAPKEY | CHAR(11), | -Join RCA 1 |
| LEAD_QUESTION | VARCHAR(500), | - Question / Current situation / |
| | | Interests |
| LEAD_ | VARCHAR(500), | - Investment / Project |
| INVESTMENT | | |
| LEAD_FOLLOWUP | VARCHAR(500), | - Important info for follow-up |
| USR_ENTRY | CHAR(11), | - Person entering lead |
| USR_ASSIGNED | CHAR(11). | - Person processing lead |
| EX_PARTNER | CHAR(30), | - Name of partner to which |
| | | lead has been exported. |
| REFUSE_TEXT | CHAR(50), | - Reason SR rejected lead |
| QUALIFIED | CHAR(1), | - Lead has been qualified |

In the following, sample implementations in pseudocode for the above tables of the database are desacribed.

TABLE ADR0
Options

pctfree 0
pctused 0
initrans 3
tablespace APP
storage
(

initial 30M
next 3M
pctincrease 0

)

Column List

| Name | Code | Type | P | M |
|---|---|---|---|---|
| au | AU | CHAR(8) | No | No |
| bu_cd | BU_CD | CHAR(4) | No | No |
| building | BUILDING | CHAR(8) | No | No |
| city | CITY | CHAR(36) | No | Yes |
| city_area | CITY_AREA | CHAR(4) | No | No |
| country_cd | COUNTRY_CD | CHAR(4) | No | No |
| dfu | DFU | CHAR(1) | No | No |
| in_work | IN_WORK | CHAR(1) | No | No |
| modified | MODIFIED | CHAR(8) | No | No |
| pkey | PKEY | CHAR(11) | Yes | Yes |
| postbox | POSTBOX | CHAR(8) | No | No |
| reclev | RECLEV | CHAR(2) | No | No |
| status | STATUS | CHAR(1) | No | No |
| street_no | STREET_NO | CHAR(40) | No | No |
| vt_rep | VT_REP | CHAR(2) | No | No |
| zip | ZIP | CHAR(6) | No | No |
| zip_comp | ZIP_COMP | CHAR(6) | No | No |
| zip_pb | ZIP_PB | CHAR(6) | No | No |
| zip_str | ZIP_STR | CHAR(6) | No | No |

Index List

| Index Code | P | F | U | C | Column Code | Sort |
|---|---|---|---|---|---|---|
| AK_ADR0_1 | No | No | No | No | ZIP | ASC |
| | | | | | PKEY | ASC |
| AK_ADR0_2 | No | No | No | No | CITY | ASC |
| | | | | | PKEY | ASC |
| UK_ADR0 | Yes | No | Yes | No | PKEY | ASC |

TABLE APM0
Options

pctfree 0
pctused 0
initrans 3
tablespace APP
storage
(

initial 15 M
next 1500 K
pctincrease 0

)

Column List

| Name | Code | Type | P | M |
|---|---|---|---|---|
| aprpkey | APRPKEY | CHAR(11) | No | No |
| au | AU | CHAR(8) | No | No |
| bu_cd | BU_CD | CHAR(4) | No | No |
| dfu | DFU | CHAR(1) | No | No |
| in_work | IN_WORK | CHAR(1) | No | No |
| modified | MODIFIED | CHAR(8) | No | No |
| pkey | PKEY | CHAR(11) | Yes | Yes |
| quantity | QUANTITY | NUMBER | No | No |
| reclev | RECLEV | CHAR(2) | No | No |
| status | STATUS | CHAR(1) | No | No |
| stdmail_cd | STDMAIL_CD | CHAR(8) | No | Yes |
| vt_rep | VT_REP | CHAR(2) | No | No |

Index List

| Index Code | P | F | U | C | Column Code | Sort |
|---|---|---|---|---|---|---|
| AK_APM0_1 | No | No | No | No | APRPKEY | ASC |
| AK_APM0_2 | No | No | No | No | STDMAIL_CD | ASC |
| UK_APM0 | Yes | No | Yes | No | PKEY | ASC |

TABLE APR0
Options

pctfree 0
pctused 0
initrans 3
tablespace APP
storage
(
initial 180M
next 18M
pctincrease 0
)

Column List

| Name | Code | Type | P | M |
|---|---|---|---|---|
| actu_state | ACTU_STATE | CHAR(2) | No | No |
| adrpkey | ADRPKEY | CHAR(11) | No | No |
| ap_hpid | AP_HPID | CHAR(16) | No | No |
| au | AU | CHAR(8) | No | No |
| best_state | BEST_STATE | CHAR(2) | No | No |
| bu_cd | BU_CD | CHAR(4) | No | No |
| build_sh | BUILD_SH | CHAR(4) | No | No |
| chk_date | CHK_DATE | DATE | No | No |
| chk_date_div | CHK_DATE_DIV | DATE | No | No |
| chk_date_job | CHK_DATE_JOB | DATE | No | No |
| chk_date_pho | CHK_DATE_PHO | DATE | No | No |
| data_cd | DATA_CD | CHAR(2) | No | No |
| data_source | DATA_SOURCE | CHAR(10) | No | No |
| del_date | DEL_DATE | DATE | No | No |
| dfu | DFU | CHAR(l) | No | No |
| div_sh | DIV_SH | CHAR(4) | No | No |
| division | DIVISION | CHAR(40) | No | No |
| email | EMAIL | CHAR(60) | No | No |
| ent_au | ENT_AU | CHAR(8) | No | No |
| ent_date | ENT_DATE | DATE | No | No |
| fax | FAX | CHAR(16) | No | No |
| first_name | FIRST_NAME | CHAR(30) | No | No |
| in_work | IN_WORK | CHAR(1) | No | No |
| job_title | JOB_TITLE | CHAR(16) | No | No |
| label_flag | LABEL_FLAG | CHAR(1) | No | No |
| lang_cd | LANG_CD | CHAR(2) | No | No |
| last_name | LAST_NAME | CHAR(30) | No | No |
| local_cd1 | LOCAL_CD1 | CHAR(4) | No | No |
| local_cd2 | LOCAL_CD2 | CHAR(4) | No | No |
| local_cd3 | LOCAL_CD3 | CHAR(4) | No | No |
| mail_titel | MAIL_TITEL | CHAR(24) | No | No |
| modified | MODIFIED | CHAR(8) | No | No |
| name_secr | NAME_SECR | CHAR(22) | No | No |
| no_callend | NO_CALLEND | DATE | No | No |
| no_callstart | NO_CALLSTART | DATE | No | No |
| no_calluser | NO_CALLUSER | CHAR(8) | No | No |
| no_faxend | NO_FAXEND | DATE | No | No |
| no_faxstart | NO_FAXSTART | DATE | No | No |
| no_faxuser | NO_FAXUSER | CHAR(8) | No | No |
| no_mailend | NO_MAILEND | DATE | No | No |
| no_mailstart | NO_MAILSTART | DATE | No | No |
| no_mailuser | NO_MAILUSER | CHAR(8) | No | No |
| phone | PHONE | CHAR(16) | No | No |
| phone_car | PHONE_CAR | CHAR(16) | No | No |
| phone_secr | PHONE_SECR | CHAR(16) | No | No |
| pkey | PKEY | CHAR(11) | Yes | Yes |
| reclev | RECLEV | CHAR(2) | No | No |
| salutation | SALUTATION | VARCHAR2(6) | No | No |
| search_key | SEARCH_KEY | CHAR(1O) | No | No |
| sex | SEX | CHAR(1) | No | No |
| ssspkey | SSSPKEY | CHAR(11) | No | No |
| status | STATUS | CHAR(1) | No | No |
| titel | TITEL | CHAR(20) | No | No |
| vt_rep | VT_REP | CHAR(2) | No | No |
| xulpkey | XULPKEY | CHAR(11) | No | No |

Index List

| Index Code | P | F | U | C | Column Code | Sort |
|---|---|---|---|---|---|---|
| AK_APR0_1 | No | No | No | No | LAST_NAME | ASC |
| | | | | | FIRST_NAME | ASC |
| | | | | | ADRPKEY | ASC |
| AK_APR0_2 | No | No | No | No | AP_HPID | ASC |
| | | | | | SSSPKEY | ASC |
| AK_APR0_3 | No | No | No | No | SSSPKEY | ASC |
| | | | | | LAST_NAME | ASC |
| AK_APR0_4 | No | No | No | No | SEARCH_KEY | ASC |
| | | | | | ADRPKEY | ASC |
| | | | | | SSSPKEY | ASC |
| AK_APR0_5 | No | No | No | No | DIVISION | ASC |
| AK_APR0_6 | No | No | No | No | ADRPKEY | ASC |
| AK_APR0_8 | No | No | No | No | SSSPKEY | ASC |
| UK_APR0 | Yes | No | Yes | No | | |

TABLE APS0
Options

pctfree 0
pctused 0
initrans 3
tablespace APP
storage
(
initial 25M
next 2500K
pctincrease 0
)

Column List

| Name | Code | Type | P | M |
|---|---|---|---|---|
| aprpkey | APRPKEY | CHAR(11) | No | No |
| au | AU | CHAR(8) | No | No |
| bu_cd | BU_CD | CHAR(4) | No | No |
| chk_date_foi | CHK_DATE_FOI | DATE | No | No |
| chk_date_loy | CHK_DATE_LOY | DATE | No | No |
| dfu | DFU | CHAR(1) | No | No |
| foi_s | FOI_S | CHAR(8) | No | Yes |
| in_work | IN_WORK | CHAR(1) | No | No |
| loyal_cd | LOYAL_CD | CHAR(2) | No | No |
| modified | MODIFIED | CHAR(8) | No | No |
| pkey | PKEY | CHAR(11) | Yes | Yes |
| reclev | RECLEV | CHAR(2) | No | No |
| status | STATUS | CHAR(1) | No | No |
| vt_rep | VT_REP | CHAR(2) | No | No |

Index List

| Index Code | P | F | U | C | Column Code | Sort |
|---|---|---|---|---|---|---|
| AK_APS0_1 | No | No | No | No | FOI_S | ASC |
| AK_APS0_2 | No | No | No | No | APRPKEY | ASC |
| | | | | | FOI_S | ASC |
| AK_APS0_3 | No | No | No | No | FOI_S | ASC |
| | | | | | APRPKEY | ASC |
| | | | | | STATUS | ASC |
| AK_APS0_4 | No | No | No | No | STATUS | ASC |
| AK_APS0_5 | No | No | No | No | VT_REP | ASC |
| UK_APS0 | Yes | No | Yes | No | PKEY | ASC |

TABLE APX0
Options

pctfree 0
pctused 0
initrans 3
tablespace APP
storage
(
initial 20M
next 2M
pctincrease 0
)

Column List

| Name | Code | Type | P | M |
|---|---|---|---|---|
| aprpkey | APRPKEY | CHAR(11) | No | No |
| au | AU | CHAR(8) | No | No |
| bu_cd | BU_CD | CHAR(4) | No | No |
| chk_date | CHK_DATE | DATE | No | No |
| dep_cd | DEP_CD | CHAR(4) | No | Yes |
| dfu | DFU | CHAR(1) | No | No |
| func_cd | FUNC_CD | CHAR(4) | No | Yes |
| in_work | IN_WORK | CHAR(1) | No | No |
| mgmt_lev | MGMT_LEV | CHAR(2) | No | No |
| modified | MODIFIED | CHAR(8) | No | No |
| pkey | PKEY | CHAR(11) | Yes | Yes |
| reclev | RECLEV | CHAR(2) | No | No |
| status | STATUS | CHAR(1) | No | No |
| vip_cd | VIP_CD | CHAR(2) | No | No |
| vt_rep | VT_REP | CHAR(2) | No | No |

Index List

| Index Code | P | F | U | C | Column Code | Sort |
|---|---|---|---|---|---|---|
| AK_APX0_1 | No | No | No | No | APRPKEY | ASC |
| | | | | | DEP_CD | ASC |
| | | | | | FUNC_CD | ASC |
| UK_APX0 | Yes | No | Yes | No | PKEY | ASC |

TABLE RCA1
Options

pctfree 0
pctused 0
initrans 3
tablespace APP
storage
(
initial 100K
next 10K
pctincrease 0
)

Column List

| Name | Code | Type | P | M |
|---|---|---|---|---|
| au | AU | CHAR(8) | No | No |
| bu_cd | BU_CD | CHAR(4) | No | No |
| camp_acc | CAMP_ACC | CHAR(8) | No | No |
| camp_cd | CAMP_CD | CHAR(10) | No | No |
| camp_desc | CAMP_DESC | CHAR(80) | No | No |
| camp_distr | CAMP_DISTR | CHAR(2) | No | No |
| camp_type | CAMP_TYPE | CHAR(4) | No | No |
| creat_date | CREAT_DATE | DATE | No | No |
| dfu | DFU | CHAR(1) | No | No |
| end_cd | END_CD | CHAR(2) | No | No |
| end_date | END_DATE | DATE | No | No |
| in_work | IN_WORK | CHAR(1) | No | No |
| modified | MODIFIED | CHAR(8) | No | No |
| pkey | PKEY | CHAR(11) | Yes | Yes |
| reclev | RECLEV | CHAR(2) | No | No |
| resp_phone | RESP_PHONE | CHAR(16) | No | No |
| responsible | RESPONSIBLE | CHAR(20) | No | No |
| select_date | SELECT_DATE | DATE | No | No |
| start_date | START_DATE | DATE | No | No |
| status | STATUS | CHAR(1) | No | No |

Index List

| Index Code | P | F | U | C | Column Code | Sort |
|---|---|---|---|---|---|---|
| AK_RCA1_1 | No | No | No | No | CAMP_CD | ASC |
| UK_RCA1 | Yes | No | Yes | No | PKEY | ASC |

TABLE RPR1
Options

pctfree 0
pctused 0
initrans 3
tablespace APP
storage
(
initial 6M
next 600K
pctincrease 0
)

Column List

| Name | Code | Type | P | M |
|---|---|---|---|---|
| adrpkey | ADRPKEY | CHAR(11) | No | No |
| apl_fam | APL_FAM | CHAR(10) | No | No |
| apl_name1 | APL_NAME1 | VARCHAR2(32) | No | No |
| apl_name2 | APL_NAME2 | VARCHAR2(32) | No | No |
| apl_quant | APL_QUANT | NUMBER | No | No |
| apl_vendor | APL_VENDOR | CHAR(10) | No | No |
| aprpkey | APRPKEY | CHAR(11) | No | Yes |
| au | AU | CHAR(8) | No | Yes |
| bu_cd | BU_CD | CHAR(4) | No | No |
| close_comm | CLOSE_COMM | VARCHAR2(80) | No | No |
| close_reas1 | CLOSE_REAS1 | CHAR(3) | No | No |
| close_reas2 | CLOSE_REAS2 | CHAR(3) | No | No |
| close_reas3 | CLOSE_REAS3 | CHAR(3) | No | No |
| close_reas4 | CLOSE_REAS4 | CHAR(3) | No | No |
| close_reas5 | CLOSE_REAS5 | CHAR(3) | No | No |
| cust_dat_a | CUST_DAT_A | CHAR(5) | No | No |
| cust_dat_c | CUST_DAT_C | CHAR(5) | No | No |
| cust_dat_d | CUST_DAT_D | CHAR(5) | No | No |
| cust_dat_f | CUST_DAT_F | CHAR(5) | No | No |
| cust_dat_h | CUST_DAT_H | CHAR(5) | No | No |
| cust_dat_i | CUST_DAT_I | CHAR(5) | No | No |
| cust_newcd | CUST_NEWCD | CHAR(1) | No | No |
| cust_st_a | CUST_ST_A | CHAR(1) | No | No |
| cust_st_c | CUST_ST_C | CHAR(1) | No | No |
| cust_st_d | CUST_ST_D | CHAR(1) | No | No |
| cust_st_f | CUST_ST_F | CHAR(1) | No | No |
| cust_st_h | CUST_ST_H | CHAR(1) | No | No |
| cust_st_i | CUST_ST_I | CHAR(1) | No | No |
| dept_cd | DEPT_CD | CHAR(4) | No | No |
| dfu | DFU | CHAR(1) | No | No |
| dsm_rem | DSM_REM | CHAR(50) | No | No |
| entry_au | ENTRY_AU | CHAR(8) | No | No |
| fam_cd | FAM_CD | CHAR(10) | No | No |
| fe_cd | FE_CD | CHAR(4) | No | No |
| forecast_cd | FORECAST_CD | CHAR(2) | No | No |
| in_work | IN_WORK | CHAR(1) | No | No |
| lstok_date | LSTOK_DATE | DATE | No | No |
| manager | MANAGER | CHAR(14) | No | No |
| modified | MODIFIED | CHAR(8) | No | No |
| ok_date | OK_DATE | DATE | No | No |
| ord_dt_old | ORD_DT_OLD | DATE | No | No |
| order_date | ORDER_DATE | DATE | No | No |
| order_value | ORDER_VALUE | NUMBER(9) | No | No |
| partner_cd | PARTNER_CD | CHAR(4) | No | No |
| partner_type | PARTNER_TYPE | CHAR(4) | No | No |
| partner1 | PARTNER1 | VARCHAR2(20) | No | No |
| partner2 | PARTNER2 | VARCHAR2(20) | No | No |
| pkey | PKEY | CHAR(11) | Yes | Yes |
| prj_cd | PRJ_CD | CHAR(2) | No | No |
| prj_desc | PRJ_DESC | VARCHAR2(240) | No | No |
| prj_end | PRJ_END | DATE | No | No |
| prj_name | PRJ_NAME | CHAR(20) | No | Yes |
| prj_phase_ap | PRJ_PHASE_AP | CHAR(4) | No | No |
| prj_phase_hp | PRJ_PHASE_HP | CHAR(4) | No | No |
| prj_start | PRJ_START | DATE | No | No |
| prj_type | PRJ_TYPE | CHAR(2) | No | No |
| probab | PROBAB | NUMBER(4) | No | No |
| prod_name | PROD_NAME | CHAR(40) | No | No |
| prod_no | PROD_NO | CHAR(14) | No | No |
| prod_type | PROD_TYPE | CHAR(4) | No | No |
| quantity | QUANTITY | NUMBER | No | No |
| rcrpkey | RCRPKEY | CHAR(11) | No | No |
| reclev | RECLEV | CHAR(2) | No | Yes |
| report_cd | REPORT_CD | CHAR(1) | No | No |
| sal_dat_a | SAL_DAT_A | CHAR(5) | No | No |
| sal_dat_b | SAL_DAT_B | CHAR(5) | No | No |
| sal_dat_c | SAL_DAT_C | CHAR(5) | No | No |
| sal_dat_d | SAL_DAT_D | CHAR(5) | No | No |
| sal_dat_e | SAL_DAT_E | CHAR(5) | No | No |
| sal_dat_f | SAL_DAT_F | CHAR(5) | No | No |
| sal_dat_g | SAL_DAT_G | CHAR(5) | No | No |
| sal_dat_h | SAL_DAT_H | CHAR(5) | No | No |
| sal_dat_i | SAL_DAT_I | CHAR(5) | No | No |
| sal_dat_k | SAL_DAT_K | CHAR(5) | No | No |
| sal_st_a | SAL_ST_A | CHAR(1) | No | No |
| sal_st_b | SAL_ST_B | CHAR(1) | No | No |
| sal_st_c | SAL_ST_C | CHAR(1) | No | No |
| sal_st_d | SAL_ST_D | CHAR(1) | No | No |
| sal_st_e | SAL_ST_E | CHAR(1) | No | No |
| sal_st_f | SAL_ST_F | CHAR(1) | No | No |
| sal_st_g | SAL_ST_G | CHAR(1) | No | No |
| sal_st_h | SAL_ST_H | CHAR(l) | No | No |
| sal_st_i | SAL_ST_I | CHAR(1) | No | No |
| sal_st_k | SAL_ST_K | CHAR(1) | No | No |
| ssspkey | SSSPKEY | CHAR(11) | No | No |
| status | STATUS | CHAR(1) | No | No |
| subfam_cd | SUBFAM_CD | CHAR(10) | No | No |
| user_name | USER_NAME | CHAR(30) | No | No |
| version | VERSION | CHAR(3) | No | No |
| xulpkey | XULPKEY | CHAR(11) | No | No |

Index List

| Index Code | P | F | U | C | Column Code | Sort |
|---|---|---|---|---|---|---|
| AK_RPR1_1 | No | No | No | No | SSSPKEY | ASC |
| AK_RPR1_2 | No | No | No | No | ADRPKEY | ASC |
| UK_RPR1 | Yes | No | Yes | No | PKEY | ASC |

TABLE SSS0
Options

pctfree 0
pctused 0
initrans 3
tablespace APP
storage
(

initial 70M
next7M
pctincrease 0

)

Column List

| Name | Code | Type | P | M |
|---|---|---|---|---|
| adrpkey | ADRPKEY | CHAR(11) | No | No |
| as_hpid | AS_HPID | CHAR(10) | No | No |
| as_type | AS_TYPE | CHAR(8) | No | No |
| au | AU | CHAR(8) | No | No |
| bu_cd | BU_CD | CHAR(4) | No | No |
| chk_date | CHK_DATE | DATE | No | No |
| comp_name1 | COMP_NAME1 | CHAR(40) | No | Yes |
| comp_name2 | COMP_NAME2 | CHAR(40) | No | No |
| comp_name3 | COMP_NAME3 | CHAR(40) | No | No |
| connected | CONNECTED | CHAR(2) | No | No |
| contract | CONTRACT | VARCHAR2(160) | No | No |
| data_source | DATA_SOURCE | CHAR(10) | No | No |
| del_date | DEL_DATE | DATE | No | No |
| dfu | DFU | CHAR(1) | No | No |
| employees | EMPLOYEES | NUMBER(8) | No | No |
| ent_au | ENT_AU | CHAR(8) | No | No |
| ent_date | ENT_DATE | DATE | No | No |
| fax | FAX | CHAR(16) | No | No |
| fisc_year | FISC_YEAR | CHAR(2) | No | No |
| in_work | IN_WORK | CHAR(1) | No | No |
| indust_cd1 | INDUST_CD1 | CHAR(6) | No | No |
| indust_cd2 | INDUST_CD2 | CHAR(6) | No | No |
| indust_cd3 | INDUST_CD3 | CHAR(6) | No | No |
| indust_cd4 | INDUST_CD4 | CHAR(6) | No | No |
| indust_cd5 | INDUST_CD5 | CHAR(6) | No | No |
| lang_cd | LANG_CD | CHAR(2) | No | No |
| local_cd1 | LOCAL_CD1 | CHAR(4) | No | No |
| local_cd2 | LOCAL_CD2 | CHAR(4) | No | No |
| local_cd3 | LOCAL_CD3 | CHAR(4) | No | No |
| modified | MODIFIED | CHAR(8) | No | No |
| phone | PHONE | CHAR(16) | No | No |
| pkey | PKEY | CHAR(11) | Yes | Yes |
| products | PRODUCTS | VARCHAR2(240) | No | No |
| reclev | RECLEV | CHAR(2) | No | No |
| sales | SALES | CHAR(9) | No | No |
| sss_search | SSS_SEARCH | CHAR(10) | No | No |
| status | STATUS | CHAR(1) | No | No |
| telex | TELEX | CHAR(16) | No | No |
| turnover | TURNOVER | NUMBER(12) | No | No |
| vt_rep | VT_REP | CHAR(2) | No | No |

Index List

| Index Code | P | F | U | C | Column Code | Sort |
|---|---|---|---|---|---|---|
| AK_SSS0_1 | No | No | No | No | COMP_NAME | ASC |
| | | | | | 1 | ASC |
| | | | | | PKEY | |
| AK_SSS0_2 | No | No | No | No | ADRPKEY | ASC |
| AK_SSS0_3 | No | No | No | No | SSS_SEARCH | ASC |
| AK_SSS0_4 | No | No | No | No | AS_HPID | ASC |
| | | | | | PKEY | ASC |
| AK_SSS0_5 | No | No | No | No | INDUST_CD1 | ASC |
| | | | | | PKEY | ASC |
| UK_SSS0 | Yes | No | Yes | No | PKEY | ASC |

TABLE XTG0
Options

pctfree 0
pctused 0
tablespace ADM
storage
(

initial 2M
next 100K
pctincrease 0
freelists 6

)

Column List

| Name | Code | Type | P | M |
|---|---|---|---|---|
| au | AU | CHAR(8) | No | No |
| bedeutung | BEDEUTUNG | CHAR(30) | No | No |
| bu_cd | BU_CD | CHAR(4) | No | No |
| code | CODE | CHAR(8) | No | No |
| dfu | DFU | CHAR(1) | No | No |
| feld_erkl | FELD_ERKL | CHAR(40) | No | No |
| feld_id | FELD_ID | CHAR(5) | No | Yes |
| in_work | IN_WORK | CHAR(1) | No | No |
| inhalt | INHALT | CHAR(8) | No | No |
| modified | MODIFIED | CHAR(8) | No | No |
| pkey | PKEY | CHAR(11) | Yes | Yes |
| reclev | RECLEV | CHAR(2) | No | Yes |
| sprache | SPRACHE | CHAR(8) | No | No |
| status | STATUS | CHAR(1) | No | No |

Index List

| Index Code | P | F | U | C | Column Code | Sort |
|---|---|---|---|---|---|---|
| AK_XTG0_1 | No | No | No | No | FELD_ID | ASC |
| | | | | | CODE | ASC |
| | | | | | BEDEUTUNG | ASC |
| AK_XTG0_2 | No | No | No | No | BU_CD | ASC |
| UK_XTG0 | Yes | No | Yes | No | PKEY | ASC |

TABLE XULO
Options

pctfree 0
pctused 0
tablespace ADM
storage
(

initial 80K
next 10K
pctincrease 0
freelists 6

)

Column List

| Name | Code | Type | P | M |
|---|---|---|---|---|
| au | AU | CHAR(8) | No | Yes |
| bu_cd | BU_CD | CHAR(4) | No | No |
| dept_cd | DEPT_CD | CHAR(4) | No | No |
| dfu | DEU | CHAR(1) | No | No |
| in_work | IN_WORK | CHAR(1) | No | No |
| manager | MANAGER | CHAR(14) | No | No |
| mandant_Cd | MANDANT_CD | CHAR(4) | No | No |
| modified | MODIFIED | CHAR(8) | No | No |
| pkey | PKEY | CHAR(11) | Yes | Yes |
| reclev | RECLEV | CHAR(2) | No | Yes |
| sr_cd1 | SR_CD1 | CHAR(4) | No | No |
| sr_cd2 | SR_CD2 | CHAR(4) | No | No |
| sr_cd3 | SR_CD3 | CHAR(4) | No | No |
| status | STATUS | CHAR(1) | No | No |
| xuspkey | XUSPKEY | CHAR(11) | No | Yes |

Index List

| Index Code | P | F | U | C | Column Code | Sort |
|---|---|---|---|---|---|---|
| AK_XUL0_1 | No | No | No | No | MANAGER | ASC |
| AK_XUL0_2 | No | No | No | No | DEPT_CD | ASC |
| UK_XUL0 | Yes | No | Yes | No | PKEY | ASC |

TABLE XUS0
Options

pcffree 0
pctused 0
tablespace ADM
storage
(

initial 250K
next 25K
pctincrease 0
freelists 6

)

Column List

| Name | Code | Type | P | M |
|---|---|---|---|---|
| au | AU | CHAR(8) | No | Yes |
| bu_cd | BU_CD | CHAR(4) | No | No |
| desc_loc | DESC_LOC | CHAR(10) | No | No |
| dfu | DFU | CHAR(1) | No | No |
| expiry_date | EXPIRY_DATE | DATE | No | No |
| function_cd | FUNCTION_CD | CHAR(2) | No | No |
| hist_frame | HIST_FRAME | CHAR(2) | No | No |
| in_work | IN_WORK | CHAR(1) | No | No |
| modified | MODIFIED | CHAR(8) | No | No |
| pkey | PKEY | CHAR(11) | Yes | Yes |
| printer | PRINTER | CHAR(9) | No | Yes |
| reclev | RECLEV | CHAR(2) | No | Yes |
| remarks | REMARKS | VARCHAR2(80) | No | No |
| sat | SAT | CHAR(8) | No | Yes |
| status | STATUS | CHAR(1) | No | No |
| sync days | SYNC_DAYS | CHAR(2) | No | No |
| user_au | USER_AU | CHAR(8) | No | Yes |
| user_name | USER_NAME | CHAR(30) | No | Yes |
| usr | USR | CHAR(8) | No | Yes |
| xugpkey | XUGPKEY | CHAR(1 1) | No | Yes |

Index List

| | | | | | Column | |
|---|---|---|---|---|---|---|
| Index Code | P | F | U | C | Code | Sort |
| AK_XUSO_1 | No | No | No | No | USER_AU | ASC |
| | | | | | USER_NA | ASC |
| | | | | | ME | |
| AK_XUSO_2 | No | No | No | No | USR | ASC |
| | | | | | STATUS | ASC |
| UK_XUSO | Yes | No | Yes | No | PKEY | ASC |

TABLE KULITAB
Options

pctfree 0
pctused 0
initrans 3
maxtrans 255
tablespace APP
storage
(
initial 1024K
next 100K
minextents 1
maxextents 249
pctincrease 0
)

Column List

| Name | Code | Type | P | M |
|---|---|---|---|---|
| AU | AU | CHAR(8) | No | No |
| BU_CD | BU_CD | CHAR(4) | No | No |
| FLAGS | FLAGS | CHAR(4) | No | No |
| MODIFIED | MODIFIED | CHAR(8) | No | No |
| Pkey | PKEY | CHAR(11) | No | No |
| SSSPKEY | SSSPKEY | CHAR(11) | No | Yes |
| UNAME | UNAME | CHAR(8) | No | Yes |

Index List

| | | | | | Column | |
|---|---|---|---|---|---|---|
| Index Code | P | F | U | C | Code | Sort |
| PK_KULITAB | No | No | No | No | SSSPKEY | ASC |
| | | | | | UNAME | ASC |

TABLE SASFUNNEL

Options
pctfree 10
pctused 40
initrans 1
maxtrans 255
tablespace SAS
storage
(
initial 20K
next 21576K
minextents 1
maxextents 249
pctincrease 50
)

Column List

| Name | Code | Type | P | M |
|---|---|---|---|---|
| AU | AU | CHAR | No | No |
| FFU_CLS_DT | FFU_CLS_DT | DATE | No | No |
| FFU_EST_PC | FFU_EST_PC | NUMBER | No | No |
| FFU_ORD_AM | FFU_ORD_AM | NUMBER | No | No |
| FFU_PROD_LINE | FFU_PROD_LINE | VARCHAR2(0) | No | No |
| FFU_PROD_NB | FFU_PROD_NB | NUMBER | No | No |
| FFU_PROD_NM | FFU_PROD_NM | VARCHAR2(0) | No | No |
| FFU_PROJ_NR | PKEY | CHAR(11) | No | No |
| FFU_SRC_{—} | FFU_SRC_{—} | VARCHAR(0) | No | No |
| DTA_CD | DTA_CD | | | |
| MODIFIED | MODIFIED | CHAR | No | No |

1. Device for conducting a business process comprising a sequence of events, which is processed by means of a data processing system within an information network divided into a proprietary and a non-proprietary part, and is represented by digital data, wherein a central data store is provided within the proprietary part of the information network for the storage of the events,
wherein at least one attribute is assigned to the events, which characterizes the event state in the course of the business process,
said device comprising:
at least one functional element provided outside the proprietary part of the information network for modifying said at least one attribute in at least one part of the sequence; and
at least one data flow control element within the proprietary part of the information network for the control of one or more data flows assigned to the events in at least one part of the sequence, having
means for examining said at least one attribute, and
means for controlling said data flows according to the respective state of the attribute.

2. Device according to claim 1, wherein the data flow control element also has a means for modifying said at least one attribute.

3. Device according to claim 1, wherein the functional element also has means for controlling the data flows assigned to the events.

4. Device according to claim 1, further comprising means that make possible an access to the data store via the information network by means of access authorization.

5. Device according to claim 1, wherein the data flow control element is hypertext-based.

6. Device according to claim 1, wherein the functional element has at least one functionality of the data flow control element in the form of a static copy.

7. Device according to claim 1, wherein the data control element and/or the functional element serves for generating the events.

8. Device according to claim 1, wherein data elements representing the data flows comprise a unified format, which is made uniform in the entire business process.

9. Device according to claim 1, wherein the functional element and/or the data flow control element have means for the synchronization of data elements representing data flows between the functional element and the data flow control element.

10. Device according to claim 1, wherein the functional element and/or the data flow control element have means for receiving and sending data elements representing the data flows.

11. Device according to claim 1, wherein the functional element and/or the data flow control element have means for manipulation of data elements representing the data flows.

12. Device according to claim 1, wherein the functional element is independent of the IT platform present each time.

13. Device according to claim 1, wherein the data flow control element has means for importing data elements as well as means for analyzing and evaluating data elements.

14. Device according to claim 1, further comprising means that make possible an access to events stored in the functional element by means of the Internet or another open network.

15. Device for conducting a business process comprising a sequence of events, which is processed by means of a data processing system and is represented by digital data,
wherein at least one attribute is assigned to the events, which characterizes the event state in the course of the business process,
said device comprising:
at least one data flow control element for controlling the data flows assigned to the events corresponding to the respective state of said at least one attribute, and
at least one automatic attribute status modifier, which automatically modifies said status of said at least one attribute when one or more conditions are fulfilled.

16. Device according to claim 15, wherein the functional element and/or the data flow control element have means for manipulation of data elements representing the data flows.

17. Device according to claim 15, wherein the automatic attribute status modifier is a timer, which automatically changes the status of said at least one attribute, if a specific attribute status is present and a specific time has passed.

18. Device according to claim 15, wherein one or more attribute statuses are not modifiable by the automatic attribute status modifier, and at least one portion of these attribute statuses can be modified by means of a manual attribute status modifier.

19. Method for conducting a business process comprising a sequence of events, which is processed by means of a data processing system and is represented by digital data, a central data store is provided for storage of events, said method comprising:
generating or modifying a state of attributes characterizing the events; and
controlling data flows assigned to the events by examining the attributes assigned to the events and controlling the data flow corresponding to the respective states of the attributes.

20. Method according to claim 19, further comprising processing the business process within an information network divided into a proprietary and a non-proprietary part, and synchronizing data elements representing the data flow, which are generated outside and/or inside the proprietary part of the information network.

21. Method according to claim 19, further comprising automatically modifying the state of the attribute, if one or more conditions are fulfilled.

22. Method according to claim 19, further comprising the step of accessing said data store via said information network by means of access authorization.

23. Computer program product, containing a program code for execution on a data processing system, said program code for conducting a business process comprising a sequence of events, which is processed by means of a data processing system and is represented by digital data, and a central data store is provided for storage of events, said program code for directing said data processing system to perform the steps of:
generating or modifying a state of attributes characterizing the events; and
controlling data flows assigned to the events by examining the attributes assigned to the events and controlling the data flow corresponding to the respective states of the attributes.

24. Device according to claim 15, wherein the functional element is independent of the IT platform present each time.

25. Device according to claim 15, wherein the data flow control element has means for importing data elements as well as means for analyzing and evaluating data elements.

26. Device according to claim 15, further comprising means that make possible an access to events stored in the functional element by means of the Internet or another open network.

27. Method according to claim 21, wherein said one or more conditions comprise a time expiration.

28. Method according to claim 19, further comprising the step of generating said events utilizing an element that controls said data flows.

29. Method according to claim 19, further comprising the step of generating said events utilizing an element that generates or modifies said state of said attributes.

30. Method according to claim 19, further comprising the step of synchronizing said data flows.

31. Method according to claim 19, further comprising the step of receiving and sending data elements representing said data flows.

32. Method according to claim 19, further comprising the step of importing data elements.

33. Method according to claim 19, further comprising the step of analyzing and evaluating data elements.

34. Method according to claim 19, further comprising the step of accessing said events by means of the Internet or another open network.
